(19) United States
(12) Patent Application Publication
(10) Pub. No.: US 2020/0039884 A1
(43) Pub. Date: Feb. 6, 2020

(54) GEOPOLYMER COMPOSITIONS AND METHODS FOR MAKING SAME

(71) Applicant: UNITED STATES GYPSUM COMPANY, Chicago, IL (US)

(72) Inventor: Ashish Dubey, Grayslake, IL (US)

(73) Assignee: UNITED STATES GYPSUM COMPANY, Chicago, IL (US)

(21) Appl. No.: 16/446,047

(22) Filed: Jun. 19, 2019

Related U.S. Application Data
(60) Provisional application No. 62/714,195, filed on Aug. 3, 2018.

(51) Int. Cl. C04B 28/14; C04B 28/10; C04B 14/06; C04B 24/04; C04B 24/26; C04B 24/38; C04B 24/32

(52) U.S. Cl. CPC C04B 28/141; C04B 28/10; C04B 28/105; C04B 28/14; C04B 2103/10; C04B 24/04; C04B 24/2676; C04B 24/38; C04B 24/32; C04B 14/06

(57) ABSTRACT

Geopolymer compositions utilizing fly ash and an inorganic mineral including alkaline earth metal oxide as cementitious reactive components. The inorganic mineral includes alkaline earth metal oxide preferably calcium oxide (also known as lime or quicklime) or magnesium oxide, or combinations thereof. The cementitious reactive powder may also optionally include one or more aluminous cements and one or more source of calcium sulfates. The cementitious reactive powders are activated with an alkali metal chemical activator selected from at least one member of the group consisting of an alkali metal salt and an alkali metal base. The inorganic minerals including alkaline earth metal oxide preferred in this invention have an alkaline earth metal oxide content preferably greater than 50 wt %, more preferably greater than 60 wt %, even more preferably greater than 70 wt %, and most preferably greater than 80 wt %, for example greater than 90 wt %. Methods for making the compositions are also disclosed.

### CROSS-REFERENCE TO RELATED APPLICATION

This claims the benefit of U.S. provisional patent application No. 62/714,195, filed Aug. 3, 2018, incorporated herein by reference.

### FIELD OF THE INVENTION

The present invention provides geopolymer compositions having enhanced performance characteristics including tailorable rheology and setting behavior, improved compressive strength, tailorable dimensional movement characteristics and excellent freeze-thaw durability behavior and method for making these compositions.

### BACKGROUND OF THE INVENTION

US 2013/0284069 A1 to Dubey, discloses Geopolymer compositions comprising reaction product of thermally activated aluminosilicate mineral/calcium aluminate cement/calcium sulfate such as anhydrous calcium sulfate/chemical activator such as alkali metal salt/water. It discloses the compositions may contain air-entraining agents or foaming agents. It also discloses using the composition for panels, road patch, traffic bearing surfaces, and pavements. It discloses some embodiments of its invention can be used with different fillers and additives including foaming agents and air entraining agents for adding air in specific proportions to make lightweight cementitious products, including precast construction elements, construction repair products, traffic bearing structures such as road compositions with good expansion properties and no shrinkage.

US 2013/0284070 A1 to Dubey, discloses a Geopolymer composition for e.g. panels comprises reaction product of thermally activated aluminosilicate mineral/calcium sulfoaluminate cement/calcium sulfate such as anhydrous calcium sulfate/chemical activator such as alkali metal salt/water. It discloses the compositions may contain air-entraining agents or foaming agents. It discloses using the composition for patching compositions for road repair, road patching, traffic bearing surfaces, and pavements. It discloses the geopolymer compositions of some embodiments of its invention can be used with different fillers and additives including foaming agents and air entraining agents for adding air in specific proportions to make lightweight cementitious products, including precast construction elements, construction repair products, and patching compositions which have good expansion properties and no shrinkage e.g. suitable for road repairs and pavements.

US 2017/0166481 A1 to Dubey discloses a freeze-thaw durable, dimensionally stable, geopolymer composition including: cementitious reactive powder including thermally activated aluminosilicate mineral, aluminate cement preferably selected from at least one of calcium sulfoaluminate cement and calcium aluminate cement, and calcium sulfate selected from at least one of calcium sulfate dihydrate, calcium sulfate hemihydrate, and anhydrous calcium sulfate; alkali metal chemical activator; and a freeze-thaw durability component selected from at least one of air-entraining agent, defoaming agent, and surface active organic polymer; wherein the composition has an air content of about 4% to 20% by volume. The compositions are made from a slurry wherein the water/cementitious reactive powder weight ratio is 0.14 to 0.55:1. Methods for making the compositions are also disclosed.

As explained by Freeze Thaw and ASTM C-672, US Spec, posted on the Internet May 21, 2010, durability is the ability of concrete to resist weathering action, chemical attack and abrasion while maintaining its desired engineering properties. How durable concrete products need to be depends on the kind of environment they will be exposed to. As cold weather approaches, concepts like freeze-thaw and resistance to deicing salts become important to understand. When water freezes, it expands 9%. As the water in moist concrete freezes, it produces pressure in the pores of concrete. If this pressure exceeds the tensile strength, the cavity will dilate and rupture. Successive freeze-thaw cycles will then eventually cause expansion and cracking, scaling, and/or crumbling of the concrete. Deicing chemicals, used for snow and ice removal, can aggravate freeze-thaw deterioration. Therefore, when using cement products, such as patching materials, on concrete roadways it is important that these materials have a strong resistance to the effects of these harsh conditions and chemicals.

### SUMMARY OF THE INVENTION

The present invention provides geopolymer compositions having enhanced performance characteristics including tailorable rheology and setting behavior, improved compressive strength, tailorable dimensional movement characteristics and excellent freeze-thaw durability behavior and methods for making these compositions.

The geopolymer compositions of the present invention utilize fly ash and an inorganic mineral comprising alkaline earth metal oxide as cementitious reactive components. The said inorganic mineral comprising alkaline earth metal oxide preferably contains calcium oxide (also known as lime or quicklime) or magnesium oxide, or combinations thereof. The cementitious reactive powder may also optionally include one or more aluminous cements and one or more source of calcium sulfates. The cementitious reactive powders are activated with an alkali metal chemical activator selected from at least one member of the group consisting of an alkali metal salt and an alkali metal base. Alkali metal citrates are the most preferred chemical activators of the present invention. Incorporation of inorganic mineral comprising alkaline earth metal oxide in the cementitious reactive powder of the invention provides various functional benefits including tailorable rheology and setting behavior, improved compressive strength, and tailorable dimensional movement behavior.

This invention provides a geopolymer composition comprising a mixture of:

cementitious reactive powder comprising:
thermally activated aluminosilicate mineral in an amount of 100 parts by weight, wherein preferably the thermally activated aluminosilicate mineral comprises at least 75% Class C fly ash,
inorganic mineral comprising alkaline earth metal oxide, wherein the inorganic mineral comprising alkaline earth metal oxide is in an amount of 0.50 to 40, preferably 1 to 30, more preferably 2 to 20 parts by weight (pbw) per 100 parts by weight of said thermally activated aluminosilicate mineral,
optionally at least one aluminate cement, and
optionally at least one calcium sulfate; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the composition has an air content of about 3% to 20% by volume, more preferably about 4% to 12% by volume, and most preferably about 4% to 8% by volume,

wherein said thermally activated aluminosilicate mineral, said optional aluminate cement, said optional calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder.

The composition was made from setting a slurry comprising water, the cementitious reactive powder, the alkali metal chemical activator, and the freeze-thaw durability component, wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1. Upon setting the water is bound to the cementitious reactive powder.

In the compositions and methods of the invention the inorganic mineral comprising alkaline earth metal oxide is alkaline earth metal oxide added in addition to the other ingredients. Thus for example, it is in addition to any alkaline earth metal oxide which may naturally be in the fly ash. This added alkaline earth metal oxide is preferably calcium oxide (also known as lime or quicklime), or magnesium oxide, or combinations thereof.

If aluminate cement and calcium sulfate are absent, the cementitious reactive powder typically has 100 pbw thermally activated aluminosilicate mineral and 0.50-40 pbw inorganic mineral comprising alkaline earth metal oxide.

If aluminate cement and calcium sulfate are absent, the cementitious reactive powder preferably has 100 pbw thermally activated aluminosilicate mineral and 1-30 pbw inorganic mineral comprising alkaline earth metal oxide.

If aluminate cement and calcium sulfate are absent, the cementitious reactive powder more preferably has 100 pbw thermally activated aluminosilicate mineral and 2-20 pbw inorganic mineral comprising alkaline earth metal oxide.

The invention also provides a method for making the above-described freeze-thaw durable, dimensionally stable, geopolymer compositions comprising the steps of:

preparing a slurry by mixing

water;

cementitious reactive powder comprising:
thermally activated aluminosilicate mineral in an amount of 100 parts by weight, wherein preferably the thermally activated aluminosilicate mineral comprises at least 75% Class C fly ash,
inorganic mineral comprising alkaline earth metal oxide, wherein the inorganic mineral comprising alkaline earth metal oxide is in an amount of 0.50 to 40, preferably 1 to 30, more preferably 2 to 20 pbw, for example 15 to 20 pbw, per 100 parts by weight of thermally activated aluminosilicate mineral,
optionally at least one aluminate cement, and
optionally at least one calcium sulfate; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the slurry has an air content of about 3% to 20% by volume, more preferably about 4% to 12% by volume, and most preferably about 4% to 8% by volume,

wherein said thermally activated aluminosilicate mineral, said optional aluminate cement, said optional calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder;

wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1, setting the slurry to form a set composition.

Preferably the mixture contains at least one member of the group consisting of the air-entraining agent and the surface active organic polymer.

The invention also provides the above geopolymer composition and methods of making same, modified to have the cementitious reactive powder further comprise aluminate cement and calcium sulfate as follows:
aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement, and
calcium sulfate in an amount of 2 to 100, preferably 5 to 75, more preferably 10 to 50 parts by weight per 100 pbw of aluminate cement, wherein the calcium sulfate is selected from at least one of calcium sulfate dihydrate, calcium sulfate hemihydrate, and anhydrous calcium sulfate.

This geopolymer composition, made from cementitious reactive powder which further comprises aluminate cement and calcium sulfate, comprises a mixture of: cementitious reactive powder comprising:
thermally activated aluminosilicate mineral in an amount of 100 parts by weight, wherein preferably the thermally activated aluminosilicate mineral comprises at least 75% Class C fly ash,
aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement,
calcium sulfate in an amount of 2 to 100, preferably 5 to 75, more preferably 10 to 50 parts by weight per 100 pbw of aluminate cement, wherein the calcium sulfate is selected from at least one member of the group consisting of calcium sulfate dihydrate, calcium sulfate hemihydrate, and anhydrous calcium sulfate, and
inorganic mineral comprising alkaline earth metal oxide, wherein the inorganic mineral comprising alkaline earth metal oxide is in an amount of 0.50 to 40, preferably 1 to 30, more preferably 2 to 20 pbw, for example 15 to 20 pbw, of thermally activated aluminosilicate mineral; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the composition has an air content of about 3% to 20% by volume, more preferably about 4% to 12% by volume, and most preferably about 4% to 8% by volume,

wherein said thermally activated aluminosilicate mineral, said aluminate cement, said calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder.

The composition was made from setting a slurry comprising water, the cementitious reactive powder, the alkali metal chemical activator, and the freeze-thaw durability component, wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1. Upon setting the water is bound to the cementitious reactive powder.

The method of the invention for making the above-described geopolymer compositions, made from cementitious reactive powder which further comprises aluminate cement, comprises the steps of:

preparing a slurry by mixing

water;

cementitious reactive powder comprising:
thermally activated aluminosilicate mineral in an amount of 100 parts by weight, wherein preferably the thermally activated aluminosilicate mineral comprises at least 75% Class C fly ash,
aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement,
calcium sulfate in an amount of 2 to 100, preferably 5 to 75, more preferably 10 to 50 parts by weight per 100 pbw of aluminate cement, wherein the calcium sulfate is selected from at least one member of the group consisting of calcium sulfate dihydrate, calcium sulfate hemihydrate, and anhydrous calcium sulfate, and
inorganic mineral comprising alkaline earth metal oxide, wherein the inorganic mineral comprising alkaline earth metal oxide is in an amount of 0.50 to 40, preferably 1 to 30, more preferably 2 to 20 pbw, for example 15 to 20 pbw, of thermally activated aluminosilicate mineral; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the slurry has an air content of about 3% to 20% by volume, more preferably about 4% to 12% by volume, and most preferably about 4% to 8% by volume,

wherein said thermally activated aluminosilicate mineral, said aluminate cement, said calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder;

wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1,

setting the slurry to form a set composition.

If aluminate cement and calcium sulfate are present, the cementitious reactive powder typically has 100 pbw thermally activated aluminosilicate mineral, 1-100 pbw aluminate cement, 2-100 pbw calcium sulfate, and 0.50-40 pbw inorganic mineral comprising alkaline earth metal oxide.

If aluminate cement and calcium sulfate are present, the cementitious reactive powder preferably has 100 pbw thermally activated aluminosilicate mineral, 2.5-80 pbw aluminate cement, 5-75 pbw calcium sulfate, and 1-30 pbw inorganic mineral comprising alkaline earth metal oxide.

If aluminate cement and calcium sulfate are present, the cementitious reactive powder more preferably has 100 pbw thermally activated aluminosilicate mineral, 5-60 pbw aluminate cement, 10-50 pbw calcium sulfate, and 2-20 pbw inorganic mineral comprising alkaline earth metal oxide.

Preferably the compositions of the present invention as well as the set compositions made by methods of the present invention have a freeze-thaw durability performance according to ASTM C666/C 666M-15 of a relative dynamic modulus of greater than 80 percent for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles.

Preferably the mixtures employed in the present invention contains at least one member of the group consisting of the air-entraining agent and the surface active organic polymer.

The compositions of the invention have a variety of uses. It can be used instead of regular Portland cement concrete for new construction or for repair and rehabilitation of old concrete. The compositions of the invention are suitable for panels, road patch, traffic bearing surfaces, and pavements. The compositions of the invention make an excellent material for concrete repair in both interior and exterior applications. For example, a preferred use is for road patching to repair a pavement or road defect. Typical defects are potholes, sinkholes, or cracks. When used as road patch the slurry is placed into the pavement or road defect and cures to form a patch having good freeze-thaw resistance. Thus, it resists cracking when exposed to multiple freeze-thaw cycles where temperature cycles below 32° F. (freeze) and above 32° F. (thaw).

The freeze-thaw durability component is one or more surface active agents selected from a group comprising of air-entraining agents, defoaming agents, and surface active organic polymers added to entrain air in the aqueous mixture in amounts that enhance and provide desired mechanical and durability performance. The mixture for the composition and method of the invention may incorporate other additives such as water reducing agents, set accelerating or retarding agents, wetting agents, colorants, fibers, rheology and viscosity modifiers, organic polymers, corrosion resistant admixtures, lightweight or other aggregates, or other additives to provide or modify the properties of the slurry and final product.

As used herein, early age strength of the composition is characterized by measuring the compressive strength after 1 to 24 hours of curing. In many applications, relatively higher early age compressive strength can be an advantage for a cementitious material because it can withstand higher stresses without excessive deformation. Achieving high early strength also increases the factor of safety relating to handling and use of manufactured products. Further, due to the achievement of high early strength, many materials and structures can be opened to traffic and allowed to support non-structural and structural loads at an early age. Typically, chemical reactions providing strength development in such compositions will continue for extended periods after the final setting time has been reached.

As used herein, later age strength of the composition is characterized by measuring the compressive strength after 7 days of curing. Ultimate compressive strength is characterized by measuring the compressive strength after 28 days of curing.

The geopolymer cementitious binders of the invention are capable of developing compressive strength of about 100 psi to about 3000 psi after 1 to 4 hours, for example 500 psi to about 3000 psi after 1 to 4 hours. The geopolymer cementitious binders of the invention are capable of developing compressive strength of about 1000 to about 6000 psi after 24 hours, for example 1500 to about 6000 psi after 24 hours. The geopolymer cementitious binders of the invention are capable of developing compressive strength of about 3000 to about 12000 psi after 28 days.

### Definitions

Herein the expression “hydraulic binder (hydraulic cement)” is understood to mean a pulverulent powdery material which, mixed with water, forms a paste which sets and hardens by a series of hydration reactions and processes and which, after hardening, retains its strength and its stability even under water.

The term “gypsum” as used herein is intended to include gypsum such as is normally understood in the art. This would include calcium sulfate (CaSO₄) and its various forms such as calcium sulfate anhydrate, calcium sulfate hemihydrate and calcium sulfate dihydrate, as well as calcined gypsum, pressure calcined gypsum and plaster of Paris.

The gypsum should have a minimum purity of 90% and be preferably finely ground to a particle size such that at least 90 wt. %, and preferably at least 99 wt. % of the gypsum particles, based on the total weight of the gypsum particles will pass through a No. 100 U.S. Standard sieve (150 microns).

The term “aluminate cement” as used herein is intended to include those cementitious materials normally understood in the art to contain as the main cementitious constituent, mono calcium aluminate (CaOAl₂O₃). The aluminate cements are any member selected from the group of calcium aluminate cement (CAC), calcium sulfoalumicate cement (CSA), calcium sulfoaluminoferrite cement, calcium sulfoferrite cement, calcium fluroalumiate cement, strontium aluminate cement, barium aluminate cement, Type-K expansive cement, Type S expansive cement, and sulfobelite cement. This would preferably include calcium aluminate cement (CAC), calcium sulfoaluminate cement (CSA). Alternative names for calcium aluminate cements are “aluminous cement”, and “high-alumina cement”. High alumina cement is normally understood in the art to contain greater than 15% of mono calcium aluminate. The surface area of the aluminate cement is preferably greater than about 3,000 cm²/gram, more preferably 3000 to 8000 cm²/gram, and further more preferably about 4,000 to 6,000 cm²/gram as measured by the Blaine surface area method (ASTM C 204).

The term “Portland cement” as used herein is intended to include those cements normally understood in the art to be “Portland cement” such as those described in British Standards Institution (BSI) EN-197 and American ASTM Standard C-150 and European Standard EN-197. The types CEM I and CEM II compositions of the latter standard are preferred for use in the present invention, although other forms of Portland cement are also suitable. Portland cement consists mainly of tri-calcium silicate and dicalcium silicate.

A monomer is a substantially mono-disperse compound of low molecular weight—typically less than one thousand Daltons—that is capable of being polymerized.

As used herein terms including “meth” in parentheses, such as “(meth)acrylate,” are intended to refer either to the acrylate or to the methacrylate, or mixtures of both. Similarly, the term (meth)acrylamide would refer either to the acrylamide or to the methacrylamide, or mixtures of both, as one skilled in the art would readily understand.

An aqueous dispersion of polymer particles is intended to encompass the meaning of latex polymer and water dispersible polymer.

A “latex” polymer means a dispersion or emulsion of polymer particles formed in the presence of water and one or more secondary dispersing or emulsifying agents (e.g., a surfactant, alkali-soluble polymer or mixtures thereof) whose presence is required to form the dispersion or emulsion. The secondary dispersing or emulsifying agent is typically separate from the polymer after polymer formation. If desired a reactive dispersing or emulsifying agent may become part of the polymer particles as they are formed.

A “water-dispersible” polymer means a polymer in powder form capable of being combined by itself with water, without requiring the use of a secondary dispersing or emulsifying agent, to obtain an aqueous dispersion or emulsion of polymer particles having at least a one month shelf stability at normal storage temperatures.

The term “surface active organic polymer” for the purposes of this invention is defined here as any organic polymeric material that is capable of entraining air in the slurry when the slurry is subjected to mechanical agitation.

The term “storage stable” as it applies to that component of the formulation which contains the hydraulic binder (hydraulic cement), is intended to mean that the hydraulic binder therein remains reactive towards water when mixed therewith after a period of storage, typically up to 1 year or greater.

The term “dry basis” means a water free basis. The term “wet basis” means a water inclusive basis, in other words based on a total aqueous composition.

### DETAILED DESCRIPTION OF THE INVENTION

Composition

This invention provides a geopolymer composition comprising a mixture of:

cementitious reactive powder comprising:
thermally activated aluminosilicate mineral in an amount of 100 parts by weight, wherein preferably the thermally activated aluminosilicate mineral comprises at least 75% Class C fly ash, and
inorganic mineral comprising alkaline earth metal oxide, wherein the inorganic mineral comprising alkaline earth metal oxide is in an amount of 0.50 to 40, preferably 1 to 30, more preferably 2 to 20 pbw per said 100 parts by weight of thermally activated aluminosilicate mineral,
optionally at least one aluminate cement, and
optionally at least one calcium sulfate; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the composition has an air content of about 3% to 20% by volume, more preferably about 4% to 12% by volume, and most preferably about 4% to 8% by volume,

wherein said thermally activated aluminosilicate mineral, said optional aluminate cement, said optional calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder.

Preferably the composition has a freeze-thaw durability performance according to ASTM C666/C 666M-15 of a relative dynamic modulus of greater than 80 percent for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles.

The invention also provides a geopolymer composition comprising a mixture of:

cementitious reactive powder comprising:
thermally activated aluminosilicate mineral in an amount of 100 parts by weight, wherein preferably the thermally activated aluminosilicate mineral comprises at least 75% Class C fly ash,
aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement, and
calcium sulfate in an amount of 2 to 100, preferably 5 to 75, more preferably 10 to 50 parts by weight per 100 pbw of aluminate cement, wherein the calcium sulfate is selected from at least one member of the group consisting of calcium sulfate dihydrate, calcium sulfate hemihydrate, and anhydrous calcium sulfate, and
inorganic mineral comprising alkaline earth metal oxide, wherein the inorganic mineral comprising alkaline earth metal oxide is in an amount of 0.50 to 40, preferably 1 to 30, more preferably 2 to 20 pbw of thermally activated aluminosilicate mineral; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the composition has an air content of about 3% to 20% by volume, more preferably about 4% to 12% by volume, and most preferably about 4% to 8% by volume, wherein said thermally activated aluminosilicate mineral, said aluminate cement, said calcium sulfate, and said inorganic mineral comprising alkaline earth metal earth oxide is at least 70 wt. %, preferably at least 80 wt. %, more preferably at least 95 wt. %, most preferably 100 wt. % of the cementitious reactive powder.

Preferably the composition has a freeze-thaw durability performance according to ASTM C666/C 666M-15 of a relative dynamic modulus of greater than 80 percent for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles.

The compositions of the invention are made from setting a slurry comprising water, the cementitious reactive powder, the alkali metal chemical activator, and the freeze-thaw durability component, wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1. Upon setting the water is bound to the cementitious reactive powder.

Preferably the composition has at least one feature selected from the group consisting of an amount of 0.01 to 1 weight % based upon the total weight of the cementitious reactive powder, of air-entraining agent, and an amount of 1 to 20 weight % based upon the total weight of cementitious reactive powder of surface active organic polymer, wherein 80 wt % of the cementitious reactive powder comprises thermally activated aluminosilicate mineral, the aluminate cement, the calcium sulfate, and the inorganic mineral comprising alkaline earth metal oxide.

Method

The invention also provides a method for making the above-described freeze-thaw durable, dimensionally stable, geopolymer compositions comprising the steps of:

preparing a slurry by mixing

water;

cementitious reactive powder comprising:
thermally activated aluminosilicate mineral in an amount of 100 parts by weight, wherein preferably the thermally activated aluminosilicate mineral comprises at least 75% Class C fly ash,
inorganic mineral comprising alkaline earth metal oxide, wherein the inorganic mineral comprising alkaline earth metal oxide is in an amount of 0.50 to 40, preferably 1 to 30, more preferably 2 to 20 pbw per 100 parts by weight of thermally activated aluminosilicate mineral,
optionally at least one aluminate cement, and
optionally at least one calcium sulfate; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the slurry has an air content of about 3% to 20% by volume, more preferably about 4% to 12% by volume, and most preferably about 4% to 8% by volume,

wherein said thermally activated aluminosilicate mineral, said optional aluminate cement, said optional calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder;

wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1,

setting the slurry to form a set composition.

Preferably the set composition has a freeze-thaw durability performance according to ASTM C666/C 666M-15 of a relative dynamic modulus of greater than 80 percent for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles.

The invention also provides a method for making the above-described geopolymer compositions, made from cementitious reactive powder which includes aluminate cement, comprising the steps of:

preparing a slurry by mixing

water;

cementitious reactive powder comprising:
thermally activated aluminosilicate mineral in an amount of 100 parts by weight, wherein preferably the thermally activated aluminosilicate mineral comprises at least 75% Class C fly ash,
aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement,
calcium sulfate in an amount of 2 to 100, preferably 5 to 75, more preferably 10 to 50 parts by weight per 100 pbw of aluminate cement, wherein the calcium sulfate is selected from at least one member of the group consisting of calcium sulfate dihydrate, calcium sulfate hemihydrate, and anhydrous calcium sulfate, and
inorganic mineral comprising alkaline earth metal oxide, wherein the inorganic mineral comprising alkaline earth metal oxide is in an amount of 0.50 to 40, preferably 1 to 30, more preferably 2 to 20 pbw of thermally activated aluminosilicate mineral; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the slurry has an air content of about 3% to 20% by volume, more preferably about 4% to 12% by volume, and most preferably about 4% to 8% by volume,

wherein said thermally activated aluminosilicate mineral, said aluminate cement, said calcium sulfate, and the inorganic mineral comprising alkaline earth metal oxide is at least 70 wt. %, preferably at least 80 wt. %, more preferably at least 95 wt. %, most preferably 100 wt. % of the cementitious reactive powder;

wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1,

setting the slurry to form a set composition.

Preferably the set composition has a freeze-thaw durability performance according to ASTM C666/C 666M-15 of a relative dynamic modulus of greater than 80 percent for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles.

Preferably the water/cementitious reactive powder weight ratio of the compositions of the invention is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1, wherein the mixture contains at least one member of the group consisting of the air-entraining agent and the surface active organic polymer. This water being the water bound to the cementitious reactive powder.

The Freeze-Thaw Durability Component could be added before water addition along with other raw materials. The cementitious reactive powder, freeze-thaw durability component, and alkali metal chemical activator are preferably combined to form a mixture and then water and air is added. The mixture can be added to the water or the water can be added to the mixture.

The alkali metal chemical activator in dry or liquid form is added to the mixture of cementitious reactive powder. If it is dry it can be added to the mixture before adding water. If liquid then it is added with the water.

In the compositions and methods, the calcium sulfate is selected from the group consisting of calcium sulfate dihydrate, calcium sulfate hemihydrate, anhydrous calcium sulfate and mixtures thereof (preferably it is added in a fine grain form with particle size less than about 300 microns).

In the compositions and methods the chemical activator is added to the cementitious reactive powder mixture either in dry or liquid form comprising an alkali metal salt or base preferably selected from the group consisting of alkali metal salts of organic acids, alkali metal hydroxides, and alkali metal silicates. In subsequent steps, water is added and optionally a superplasticizer is added, particularly a carboxylated plasticizer material, to form stable slurry mixtures that can be used in applications suitable for geopolymeric cementitious products.

The compositions of the present invention or made in the methods of the present invention may optionally include calcium sulfoaluminate cements and/or calcium aluminate cements. For example, the invention permits the following three compositions:
compositions including both a calcium sulfoaluminate cement and a calcium aluminate cement;
compositions including calcium sulfoaluminate cement but not calcium aluminate cement;
compositions including only calcium aluminate cement but not calcium sulfoaluminate cement.

The compositions of the invention or made in the method of the present invention may incorporate other additives not considered cementitious reactive powder such as superplasticizers, water reducing agents, set accelerating agents, set retarding agents, wetting agents, fibers, rheology modifiers, organic polymers, shrinkage control agents, viscosity modifying agents (thickeners), film-forming redispersible polymer powders, film-forming polymer dispersions, coloring agents, corrosion control agents, alkali-silica reaction reducing admixtures, discrete reinforcing fibers, and internal curing agents.

The compositions of the invention or made in the method of the present invention may incorporate other additives not considered cementitious reactive powder to provide or modify the properties of the slurry and final product. These additives are pozzolanic mineral, and fillers selected from the group consisting of one or more of sand, lightweight aggregates, lightweight fillers, mineral fillers, and aggregates other than sand.

The compositions of the invention or made in the method of the present invention have no loss in mechanical performance and durability, as demonstrated by the measured parameter relative dynamic modulus, for at least 100 freeze-thaw cycles, typically at least 300 freeze-thaw cycles, preferably at least 600 freeze-thaw cycles, more preferably at least 900 freeze-thaw cycles and most preferably at least 1200 freeze-thaw cycles. The freeze-thaw durability testing is conducted based on ASTM C666—Procedure A. The version of this standard is ASTM C666/C666M-15 (published 2015). The nominal freezing and thawing cycle shall consist of alternately lowering the temperature of the specimens from 40 to 0° F. [4 to −18° C.] and raising it from 0 to 40° F. [−18 to 4° C.] in not less than 2 nor more than 5 hours. The temperature was measured using thermocouple in a freeze-thaw cabinet. The dimensions of the rectangular prism specimen used for freeze-thaw durability testing were as follows: 3 inches (width)×4 inches (thickness)×16 inches (length).

Based on ASTM C666 the durability factor of the test specimen can be

$$DF = \frac{P * N}{M}$$

calculated as follows:

where:

DF=durability factor of the test specimen,
P=relative dynamic modulus of elasticity at N cycles, %,
N=number of cycles at which P reaches the specified minimum value for discontinuing the test or the specified number of cycles at which the exposure is to be terminated, whichever is less, and
M=specified number of cycles at which the exposure is to be terminated. M value based on ASTM C666 is 300.

The compositions of the invention or made in the method of the present invention have beneficial properties as measured by the salt scaling resistance test per ASTM C672/C672M-12, Standard Test Method for Scaling Resistance of Concrete Surfaces Exposed to Deicing Chemicals, ASTM, published 2012. The dimensions of the specimen used for salt scaling durability testing were 8.75 inches (length)×8.3125 inches (width)×3 inches (thickness).

Initial Slurry Temperature and Slurry Temperature Rise

In the present invention, to form the composition, the Cementitious Reactive Powder Component (thermally activated aluminosilicate mineral, aluminate cement, and calcium sulfate), Activator Component (alkali metal chemical activator), and water are mixed to form a cementitious slurry at an initial slurry temperature. The slurry is formed under conditions which provide a reduced initial mixture slurry temperature and a controlled temperature. This leads to formation of aluminosilicate geopolymer reaction species and setting and hardening of the resulting material. Simultaneously, hydration reactions of calcium silicate as well as calcium aluminate and/or calcium sulfoaluminate phases also occur leading to setting and hardening of the resulting material.

The initial temperature is defined as the temperature of the overall mixture during the first minute after the cementitious reactive powder, activator, and water are first all present in the mixture. Of course the temperature of the overall mixture can vary during this first minute but to achieve preferred thermal stability it will preferably remain within an range initial temperature range of about 0 to about 122° F. (0 to 50° C.), preferably about 41 to about 104° F. (5 to 40° C.), more preferably about 50 to about 95° F. (10 to 35° C.) and, most preferably ambient temperature (room temperature) of about 77° F. (25° C.).

Increasing the initial temperature of the slurry increases the rate of temperature rise as the reactions proceed and reduces the setting time. Thus, initial slurry temperature of 95° F. (35° C.) to 105° F. (41.1° C.) used in preparing conventional fly ash based geopolymeric compositions for rapid gelation and setting times is preferably avoided since the composition formulation is designed to reduce temperature increase behavior of the mixed composition from the initial slurry temperatures.

The controlled temperature rise is less than about 50° F. (28° C.) to a final composition mixture slurry temperature, more preferably a rise of less than about 40° F. (22° C.) and more preferably a rise of less than about 30° F. (17° C.) for improved temperature stability and more importantly, slower gelation and final setting times of from about 10 to about 240 minutes, more preferably about 60 to about 120 minutes and more preferably about 30 to about 90 minutes. This allows for more controlled working time for commercial use of the compositions of the invention. The setting time of the slurry is adjusted based on the final use requirements.

Material Exothermic and Temperature Rise Behavior

Compositions of the present invention advantageously achieve moderate heat evolution and low temperature rise within the material during the curing stage. In such compositions, the maximum temperature rise occurring in the material is preferably less than about 50° F. (28° C.), more preferably less than about 40° F. (22° C.), and most preferably less than about 30° F. (17° C.). This prevents excessive thermal expansion and consequent cracking and disruption of material.

Aerating

The aqueous mixture of this invention can be aerated by mechanically mixing the slurry comprising freeze-thaw durability component as disclosed in this invention. It has unexpectedly been determined that the high shear mixers (RPM>100) tend to entrain about 2 to 3 times more air in the slurry when compared to the low shear mixers (RPM<100).

The preferred method for mixing rapid setting geopolymer compositions of the invention with an objective of obtaining superior freeze-thaw durability performance is by utilizing a low shear mixer. Preferably, the low shear mixers useful in this invention are capable of mixing at a speed of 100 RPM or lower. More preferably, the low shear mixers useful in this invention are capable of mixing at a speed of 50 RPM or lower. Most preferably, the low shear mixers useful in this invention are capable of mixing at a speed of 25 RPM or lower.

The preferred slurry mixing time using a low shear mixer (<100 RPM) is between 2 to 12 minutes. More preferred mixing time using a low shear mixer is between 3 to 10 minutes. The most preferred mixing time using a low shear mixer is between 4 to 8 minutes.

The preferred mixing time using a high shear mixer (>100 RPM) is 1.5 to 8 minutes. More preferred mixing time using a high shear mixer is between 2 to 6 minutes. While the most preferred mixing time using a high shear mixer is between 3 to 4 minutes.

Preferably the composition is aerated in the field. This is advantageous when repairing roads, for example at the road site where a pothole is being repaired.

Ingredients of the Composition of the Invention or Used in the Method to Make the Composition of the Invention

TABLE AA and TABLE AB summarize components of the composition and method of the present invention. Each “Preferred” range or “More Preferred” range is individually a preferred range or more preferred range for the invention. Thus, preferably any “Preferred” range can be independently substituted for a corresponding “Useable range”. More preferably any “More Preferred range” can be independently substituted for a corresponding “Useable” range or a corresponding “Preferred range”.

TABLE AA
Freeze-Thaw Durable reactive geopolymer cementitious compositions
of the invention (in parts by weight unless otherwise specified)

| | | | More |
|---|---|---|---|
| | Useable | Preferred | Preferred |
| Cementitious Reactive Powder | | | |
| Component A: | | | |
| a. Thermally activated | 100 | 100 | 100 |
| aluminosilicate mineral (parts by | | | |
| weight, pbw) | | | |
| b. Inorganic mineral comprising | 0.50-40 | 1-30 | 2-20 |
| alkaline earth metal oxide (pbw | | | |
| per 100 pbw of thermally activated | | | |
| aluminosilicate mineral) | | | |
| Activator Component B: | | | |
| Alkali metal chemical activator | 1 to 6% | 1.25 to 4% | 1.5 to 2.5% |
| (weight % based upon the total | | | |
| weight of Component A) | | | |
| Freeze-Thaw Durability | | | |
| Component C: | | | |
| One or more surface active agents | | | |
| (weight % based upon the total | | | |
| weight of Component A) | | | |
| Air-entraining agent (weight % | 0.0-1% | 0.01-0.5% | 0.05-0.2% |
| based upon the total weight of | | | |
| Component A) | | | |
| Defoaming agent (weight % | 0-0.5% | 0-0.25% | 0.01-0.1% |
| based upon the total weight of | | | |
| Component A) | | | |
| Surface active organic polymer | 0-20% | 0-10% | 1-5% |
| (weight % based upon the total | | | |
| weight of Component A) | | | |

The Freeze-Thaw Durability Component C contains at least one member
of the group consisting of the air-entraining agent and the surface active
organic polymer.

TABLE AB
Freeze-Thaw Durable reactive geopolymer cementitious compositions
of the invention (in parts by weight unless otherwise specified)

| | | | More |
|---|---|---|---|
| | Useable | Preferred | Preferred |
| Cementitious Reactive Powder | | | |
| Component A: | | | |
| a. Thermally activated | 100 | 100 | 100 |
| aluminosilicate mineral (parts by | | | |
| weight, pbw) | | | |
| b. aluminate cement (pbw per | 1-100 | 2.5-80 | 5-60 |
| 100 pbw of thermally activated | | | |
| aluminosilicate mineral) | | | |
| c. Calcium sulfate (pbw per | 2-100 | 5-75 | 10-50 |
| 100 pbw of mixture of aluminate | | | |
| cement) | | | |
| d. Inorganic mineral comprising | 0.50-40 | 1-30 | 2-20 |
| alkaline earth metal oxide (pbw | | | |
| per 100 pbw of thermally | | | |
| activated aluminosilicate mineral) | | | |
| Activator Component B: | | | |
| Alkali metal chemical activator | 1 to 6% | 1.25 to 4% | 1.5 to 2.5% |
| (weight % based upon the total | | | |
| weight of Component A) | | | |
| Freeze-Thaw Durability | | | |
| Component C: | | | |
| One or more surface active agents | | | |
| (weight % based upon the total | | | |
| weight of Component A) | | | |
| Air-entraining agent (weight % | 0.0-1% | 0.01-0.5% | 0.05-0.2% |
| based upon the total weight of | | | |
| Component A) | | | |
| Defoaming agent (weight % | 0-0.5% | 0-0.25% | 0.01-0.1% |
| based upon the total weight of | | | |
| Component A) | | | |
| Surface active organic polymer | 0-20% | 0-10% | 1-5% |
| (weight % based upon the total | | | |
| weight of Component A) | | | |

The Freeze-Thaw Durability Component C contains at least one
member of the group consisting of the air-entraining agent and the
surface active organic polymer.

Cementitious Reactive Powder Component A is the total of the thermally activated aluminosilicate (preferably comprising Class C fly ash), aluminate cement, and calcium sulfate, and, if present, other cements (for example, Portland cement or Calcium Fluoroaluminate). However, Cementitious Reactive Powder Component A is at least 70 wt. %, preferably at least 80 wt. %, more preferably at least 95 wt. %, most preferably 100 wt. % thermally activated aluminosilicate mineral, aluminate cement, calcium sulfate, and inorganic mineral comprising alkaline earth metal oxide.

In the present specification composition percentages and ratios are weight percents and weight ratios unless otherwise specified.

The invention encompasses compositions and methods in which aluminate cement is absent. The invention encompasses compositions and methods in which Calcium aluminate cement is absent. The invention encompasses compositions and methods in which Calcium sulfoaluminate cement is absent. The invention encompasses compositions and methods in which Calcium sulfate is absent. The invention encompasses compositions and methods in which Calcium aluminate cement, Calcium sulfoaluminate cement, and Calcium sulfate are absent.

The invention encompasses compositions and methods in which Calcium sulfoaluminate cement is provided in the absence of Calcium aluminate cement, wherein the composition has Calcium sulfoaluminate cement in an amount of 2-100, preferably 2.5-50, more preferably 5-30, most preferably 25 to 40 parts by weight (pbw) per 100 pbw of thermally activated aluminosilicate mineral.

The invention encompasses compositions and methods in which Calcium aluminate cement is provided in the absence of Calcium sulfoaluminate cement, wherein the composition has Calcium aluminate cement in an amount of 2-100, preferably 2.5-80, more preferably 5-60, most preferably 25 to 40 parts by weight (pbw) per 100 pbw of thermally activated aluminosilicate mineral.

The invention encompasses compositions and methods in which Calcium aluminate cement is provided with Calcium sulfoaluminate cement, wherein the composition has total aluminate cement in an amount of 2-100, preferably 2.5-80, more preferably 5-60, most preferably 25 to 40 parts by weight (pbw) per 100 pbw of thermally activated aluminosilicate mineral.

The invention encompasses compositions and methods in which Portland cement is absent.

The invention encompasses compositions and methods in which Portland cement, Calcium aluminate cement, Calcium sulfoaluminate cement and Calcium sulfate are absent.

The geopolymer cementitious compositions of the present invention can be used where other cementitious materials are used; particularly applications where freeze-thaw resistance is important, setting and working time flexibility, dimensional stability, compressive strength and/or other strength properties are important or necessary.

Slurries used to make compositions of the invention have the amounts of air and water listed in TABLE A-1. Each “Useable” range, “Preferred” range or “More Preferred” range is individually a useable, preferred range or more preferred range for the invention. Thus, the useable ranges of components of TABLE A-1 would be used with the useable ranges of components of TABLES AA and AB. However, preferably any “Preferred” range can be independently substituted for a corresponding “Useable range”. More preferably any “More Preferred range” can be independently substituted for a corresponding “Useable” range or a corresponding “Preferred range”.

TABLE A-1
Amounts of Air and Water in Compositions of the present invention

| | | | More |
|---|---|---|---|
| | Useable | Preferred | preferred |
| Water/Cementitious Reactive Powder | 0.14-0.55 | 0.16-0.50 | 0.18-0.45 |
| Component A Ratio (by weight) | | | |
| Air (volume % of slurry) | 3-20 | 4-12 | 4-8 |

As a result, products of the present invention have these amounts of air as void spaces. Also as a result, products of the present invention have up to these amounts of water bound to the cement by reacting and hydrating the cementitious materials of Component A in presence of Component B. In the invention water is provided to accomplish the chemical hydration and aluminosilicate geopolymerization reactions in compositions of the invention. Hydration reactions of calcium silicate as well as calcium aluminate and/or calcium sulfoaluminate phases also occur leading to setting and hardening of the resulting material. The chemical reaction between cement and water, known as hydration, produces heat known as heat of hydration. Also, when mixed with the water at normal (ambient) temperatures, calcined gypsum reverts chemically to the dihydrate form while physically “setting”: CaSO₄.½H₂O+1½ H₂O→CaSO₄.2H₂O. Gypsum is highly soluble and rapidly releases calcium and sulfate into the slurry. The presence of the sulfate ions causes calcium aluminate to react such that Calcium aluminate and CaSO₄.2H₂O to form the mineral ettringite.

Calcium sulfates (different forms) react with calcium aluminates to form calcium sulfoaluminate hydrates. Presence of calcium sulfates also appears to influence formation of products of geopolymerization reactions such as sodium alumino silicate hydrate (NASH) gels and calcium alumino silicate hydrate (CASH) gels.

The geopolymer reaction of aluminosilicate mineral such as fly ash with an alkali metal activator such as alkali metal citrate is known to involve an extremely rapid rate of reaction in which significant amount of heat is released due to the exothermic reaction involved. This rapid rate of exothermic reaction leads to the formation of aluminosilicate compounds and the material gels-up and hardens extremely quickly (in a matter of minutes).

Similarly, interaction of calcium sulfoaluminate cement with calcium sulfate also is known to involve an extremely rapid rate of reaction in which significant amount of heat is released due to the exothermic reaction. As a result of this rapid exothermic reaction, hydration products of calcium sulfoaluminate compound are formed and the material gels-up and hardens extremely quickly, again in a matter of minutes. An extremely short setting time is problematic in some applications since it provides a short working life (pot life) that causes significant difficulties with processing and placement of rapid setting material in actual field applications. Also, the large amount of heat generated by the rapid exothermic reactions can lead to undesirable thermal expansion and consequent cracking and disruption of material.

Setting of the composition is characterized by initial and final set times, as measured using Vicat needle specified in the ASTM C191 test procedure. The final set time also corresponds to the time when a concrete product, e.g., a concrete panel, has sufficiently hardened so that it can be handled.

The present invention employs the reaction of thermally activated aluminosilicate mineral comprising Class C fly ash, inorganic mineral comprising alkaline earth metal oxide, alkali metal chemical activator, optional aluminate cement (calcium aluminate cement and/or calcium sulfoaluminate cement), and optional calcium sulfate. They interact synergistically with each other as part of the geopolymerization reaction to increase the gelation time and final setting time of the resulting material. Appropriate selection of the type of alkaline earth metal oxide and its amount, the type of calcium sulfate and its amount, the type of aluminate cement and its amount, and the alkali metal chemical activator and its amount are effective in prolonging the gelation rate and period and the final setting time of the resulting material. This allows longer open and working times for the geopolymer cementitious compositions.

Other additives not considered cementitious reactive powder may be incorporated into the slurry and overall geopolymeric cementitious composition of this invention. Such other additives, for example, water reducing agents such as superplasticizers, set accelerating agents, set retarding agents, wetting agents, shrinkage control agents, viscosity modifying agents (thickeners), film-forming redispersible polymer powders, film-forming polymer dispersions, coloring agents, corrosion control agents, alkali-silica reaction reducing admixtures, discrete reinforcing fibers, and internal curing agents. Other additives may include fillers, such as one or more of sand, coarse aggregates, lightweight fillers, pozzolanic minerals, and mineral fillers.

All percentages in the specification are weight percents unless otherwise indicated (for example air percents are volume percents). All ratios in the specification are weight ratios unless otherwise indicated.

TABLE A-2 lists amounts of additives employed in compositions of the present invention. Each “Useable” range, “Preferred” range or “More Preferred” range of TABLE A-2 is individually a useable, preferred range or more preferred range for the invention. Thus, the useable ranges of components of TABLE A-2 would be used with the useable ranges of components of TABLE AA, TABLE AB and TABLE A-1. However, preferably any “Preferred” range can be independently substituted for a corresponding “Useable range”. More preferably any “More Preferred range” can be independently substituted for a corresponding “Useable” range or a corresponding “Preferred range”.

Some additives of TABLE A-2 are species of ingredients listed in TABLE AA and TABLE AB. For example, TABLE AA and TABLE AB lists Surface active organic polymer. Surface active organic polymer includes Bio-polymers, Organic Rheology Control Agents, and Film-forming polymer additives. Two species of Film-forming polymer additives are Film Forming Redispersible Polymer Powder and Film Forming Polymer Dispersion. Some of the additives of TABLE A-2 are ingredients in addition to those of TABLE AA and TABLE AB, for example pigments.

TABLE A-2
Additive Ingredient Amounts for Compositions of the Present Invention

| | | | More |
|---|---|---|---|
| Ingredient* | Useable | Preferred | preferred |
| Superplasticizer/Cementitious | 0 to 4.0% | 0.25-2.5% | 0.50-1.5% |
| Reactive Powder Component A | | | |
| (weight %) | | | |
| Fine Aggregate (Sand is a | 0-5:1 | 0-4:1 | 1-3.5:1 |
| preferred fine aggregate)/ | | | |
| Cementitious Reactive Powder | | | |
| Component A Ratio (by weight) | | | |
| Inorganic Mineral Filler/ | 0-2:1 | 0-1:1 | 0-0.5:1 |
| Cementitious Reactive Powder | | | |
| Component A Ratio (by weight) | | | |
| Organic Rheology Control | 0-0.50% | 0-0.25% | 0-0.15% |
| Agent/Cementitious Reactive | | | |
| Powder Component A | | | |
| (weight %) | | | |
| Inorganic Rheology Control | 0-3% | 0-2% | 0-1% |
| Agent/Cementitious Reactive | | | |
| Powder Component A | | | |
| (weight %) | | | |
| Coloring Pigments/Cementitious | 0-5% | 0-2.5% | 0-1% |
| Reactive Powder Component A | | | |
| (weight %) | | | |
| Efflorescence Suppression | 0-3% | 0-2% | 0-1% |
| Agent/Cementitious Reactive | | | |
| Powder Component A | | | |
| (weight %) | | | |
| Film Forming Redispersible | 0-20% | 0-10% | 0-5% |
| Polymer Powder/Cementitious | | | |
| Reactive Powder Component A | | | |
| (weight %) | | | |
| Film Forming Polymer | 0-20% | 0-10% | 0-5% |
| Dispersion/Cementitious | | | |
| Reactive Powder Component A | | | |
| (weight % of active ingredient) | | | |
| Lightweight Filler/Cementitious | 0-2:1 | 0-1:1 | 0-0.75:1 |
| Reactive Powder Component A | | | |
| Ratio (by weight) | | | |
| Coarse Aggregate/Cementitious | 0-5.5:1 | 0-5:1 | 0-4.5:1 |
| Reactive Powder Component A | | | |
| Ratio (by weight) | | | |
| Naturally-occurring or Non- | 0-1:1 | 0-0.5:1 | 0-0.25:1 |
| thermally Activated Pozzolans/ | | | |
| Cementitious Reactive Powder | | | |
| Component A Ratio (by weight) | | | |

*The notation ″ingredient/Cementitious Reactive Powder Component A (weight %)″ in the present specification, unless otherwise specified, means amount of the ingredient equals the specified weight percent of the Cementitious Reactive Powder Component A. For example, a range of 0-4 wt % for superplasticizer means for 100 pounds of Cementitious Reactive Powder Component A there is additionally 0-4 pounds of superplasticizer.

Preferably there is at least 1 part by weight total fine and coarse aggregate per 1 part total weight of the cementitious reactive powder. More preferably there is 1 to 8 parts by weight total fine and coarse aggregate per 1 part total weight of the cementitious reactive powder.

TABLE B represents full density (preferably densities in the range of 100 to 160 pounds per cubic foot) formulations incorporating the compositions of TABLES AA, AB, A-1 and A-2 and specific amounts of the listed ingredients. These full density compositions employ the amounts of ingredients in TABLE AA, TABLE AB, TABLE A-1, and TABLE A-2 but replace the amounts of fine aggregate (sand) with the amount in TABLE B and have an absence of lightweight filler and coarse aggregate.

TABLE B
Amounts of Fine Aggregate (Sand) for full density compositions in the
absence of coarse aggregate and lightweight filler

| | | | More |
|---|---|---|---|
| Ingredient | Useable | Preferred | preferred |
| Fine Aggregate (Sand)/Cementitious | 0-5:1 | 0.50-4:1 | 0.75-3.5:1 |
| Reactive Powder Component A Ratio | | | |
| (by weight) | | | |

TABLE C represents the amounts of sand and lightweight filler for lightweight density (preferably densities in the range of 10 to 125 pounds per cubic foot) compositions incorporating the compositions of TABLE AA or TABLE AB, TABLE A-1, and TABLE A-2. These lightweight compositions employ the amounts of ingredients in TABLE AA, TABLE AB, TABLE A-1, and TABLE A-2 but replace the amounts of sand and lightweight filler with the amounts in TABLE C and have an absence of coarse aggregate.

TABLE C
Amounts of Sand and lightweight filler for lightweight
density compositions

| | | | More |
|---|---|---|---|
| Ingredient | Useable | Preferred | preferred |
| Fine Aggregate (Sand)/Cementitious | 0-4:1 | 0-2:1 | 0-1.5:1 |
| Reactive Powder Component A Ratio | | | |
| (by weight) | | | |
| Lightweight Filler/Cementitious | 0-2:1 | 0.01-1:1 | 0.02-0.75:1 |
| Reactive Powder Component A Ratio | | | |
| (by weight) | | | |

TABLE D represents lightweight or full density (preferably densities in the range of 40 to 160 pounds per cubic foot) formulations incorporating the composition of TABLE AA or TABLE AB, coarse aggregate and other ingredients. These compositions employ the amounts of ingredients in TABLE AA, TABLE AB, TABLE A-1, and TABLE A-2 but replace the amounts of fine aggregate (sand), lightweight filler and coarse aggregate with the amounts in TABLE D

TABLE D
Amounts for full or lightweight density compositions incorporating
coarse aggregate

| | | | More |
|---|---|---|---|
| Ingredient | Useable | Preferred | preferred |
| Fine Aggregate (Sand)/Cementitious | 0-5:1 | 0.50-4:1 | 1-3.5:1 |
| Reactive Powder Component A Ratio | | | |
| (by weight) | | | |
| Lightweight Filler/Cementitious | 0-2:1 | 0-1:1 | 0-0.50:1 |
| Reactive Powder Component A Ratio | | | |
| (by weight) | | | |
| Coarse Aggregate/Cementitious | 0.5-5.5:1 | 0.5-5:1 | 1-4.5:1 |
| Reactive Powder Component A Ratio | | | |
| (by weight) | | | |

The following describes the individual categories of ingredients.

Cementitious Reactive Mixture

The cementitious reactive mixture of the present invention comprises Cementitious Reactive Powder Component A (also known herein as Cementitious Reactive Material or Cementitious Materials), Activator Component B, and Freeze-Thaw Durability Component C with ranges as shown in TABLE AA and TABLE AB.

In the compositions and methods of the invention the inorganic mineral comprising alkaline earth metal oxide is alkaline earth metal oxide added in addition to the other ingredients. Thus for example, it is in addition to any alkaline earth metal oxide which may naturally be in the fly ash. This added alkaline earth metal oxide is preferably calcium oxide (also known as lime or quicklime), or magnesium oxide, or combinations thereof.

In addition to the thermally activated aluminosilicate mineral, inorganic mineral comprising alkaline earth metal oxide, optional calcium sulfate, and optional aluminate cement, for example optional calcium aluminate cement, and optional calcium sulfoaluminate cement, the cementitious reactive powder may include about 0 to about 15 wt. % of optional cementitious additives such as Portland cement. However, preferably there is an absence of Portland cement as its incorporation increases the material shrinkage making the material less dimensionally stable. Pozzolans other than thermally activated aluminosilicate mineral are considered part of the cementitious reactive powder. The cementitious reactive powder may have an absence of any one or more of calcium sulfate and aluminate cement, for example calcium aluminate cement and calcium sulfoaluminate cement.

Cementitious Reactive Powder Component a (Also Known Herein as Cementitious Reactive Material or Cementitious Materials)

The Cementitious Reactive Powder Component A comprises thermally activated aluminosilicate mineral and inorganic mineral comprising alkaline earth metal oxide, preferably calcium oxide and/or magnesium oxide. Optionally the Cementitious Reactive Powder Component A further comprises at least one aluminate cement and at least one calcium sulfate. Optionally the Cementitious Reactive Powder Component A comprises other cements and/or non-thermally activated pozzolans.

The aluminate cement is preferably selected from at least one of calcium aluminate cements and calcium sulfoaluminate cements. In other words at least one calcium aluminate cement, or at least one calcium sulfoaluminate cement, or mixtures thereof.

The calcium sulfate can be any of calcium sulfate dihydrate, calcium sulfate hemihydrate, or calcium sulfate anhydrite.

The thermally activated aluminosilicate mineral is selected from at least one member of the group consisting of fly ash, blast furnace slag, thermally activated clays, shales, metakaolin, zeolites, marl red mud, ground rock, and ground clay bricks. Preferably, they have Al₂O₃ content greater than about 5% by weight. Preferably clay or marl is used after thermal activation by heat treatment at temperatures of from about 600° to about 850° C. The preferred thermally activated aluminosilicate minerals of compositions of the invention have high lime (CaO) content in the composition, preferably greater than about 10 wt %, more preferably greater than about 15%, and still more preferably greater than about 20%. The most preferred thermally activated aluminosilicate mineral is Class C fly ash, for example, fly ash procured from coal-fired power plants. The thermally activated aluminosilicate minerals also possess pozzolanic properties.

Thermally activated aluminosilicate minerals are aluminosilicate minerals that have undergone high temperature heat treatment. Preferably thermal activation occurs at a temperature in the range of 750-1500° C.

Fly ash is the preferred thermally activated aluminosilicate mineral in the cementitious reactive powder blend of the invention. Fly ashes containing high calcium oxide and calcium aluminate content, such as Class C fly ashes of ASTM C618 (2008) standard, are preferred as explained below.

Fly ash is a fine powder byproduct formed from the combustion of coal. Electric power plant utility boilers burning pulverized coal produce most commercially available fly ashes. These fly ashes consist mainly of glassy spherical particles as well as residues of hematite and magnetite, char, and some crystalline phases formed during cooling. The structure, composition and properties of fly ash particles depend upon the structure and composition of the coal and the combustion processes by which fly ash is formed. ASTM C618 (2008) standard recognizes two major classes of fly ashes for use in concrete—Class C and Class F. These two classes of fly ashes are generally derived from different kinds of coals that are a result of differences in the coal formation processes occurring over geological time periods. Class F fly ash is normally produced from burning anthracite or bituminous coal, whereas Class C fly ash is normally produced from lignite or sub-bituminous coal.

The ASTM C618 (2008) standard differentiates Class F and Class C fly ashes primarily according to their pozzolanic properties. Accordingly, in the ASTM C618 (2008) standard, the major specification difference between the Class F fly ash and Class C fly ash is the minimum limit of SiO₂+Al₂O₃+Fe₂O₃ in the composition. The minimum limit of SiO₂+Al₂O₃+Fe₂O₃ for Class F fly ash is 70% and for Class C fly ash is 50%. Thus, Class F fly ashes are more pozzolanic than the Class C fly ashes. Although not explicitly recognized in the ASTM C618 (2008) standard, Class C fly ashes preferably have high calcium oxide (lime) content.

Class C fly ash usually has cementitious properties in addition to pozzolanic properties due to free lime (calcium oxide). Class F is rarely cementitious when mixed with water alone. Presence of high calcium oxide content makes Class C fly ashes possess cementitious properties leading to the formation of calcium silicate and calcium aluminate hydrates when mixed with water.

The thermally activated aluminosilicate mineral comprises Class C fly ash, preferably, about 50 to about 100 parts Class C fly ash per 100 parts thermally activated aluminosilicate mineral, more preferably the thermally activated aluminosilicate mineral comprises about 75 parts to about 100 parts Class C fly ash per 100 parts thermally activated aluminosilicate mineral.

Other types of fly ash, such as Class F fly ash, may also be employed. Preferably, at least about 50 wt. % of the thermally activated aluminosilicate mineral in the cementitious reactive powder is Class C fly ash with the remainder Class F fly ash or any other thermally activated aluminosilicate mineral. More preferably, about 55 to about 75 wt. % of the thermally activated aluminosilicate mineral in the cementitious reactive powder is Class C fly ash with the remainder Class F or any other thermally activated aluminosilicate mineral. Preferably the thermally activated aluminosilicate mineral is about 90 to about 100% Class C fly ash, for example 100% Class C Fly ash.

The average particle size of the thermally activated aluminosilicate minerals of the invention is preferably less than about 100 microns, preferably less than about 50 microns, more preferably less than about 25 microns, and still more preferably less that about 15 microns.

Typically the mixture composition of the invention has at most about 5 parts metakaolin per 100 parts thermally activated aluminosilicate mineral. Preferably, the compositions of the invention have an absence of metakaolin. Presence of metakaolin has been found to increase the water demand of the mixtures hence its use is generally not desirable in the geopolymer compositions of the invention.

Minerals often found in fly ash are quartz (SiO₂), mullite (Al₂Si₂O₁₃), gehlenite (Ca₂Al₂SiO₇), hematite (Fe₂O₃), magnetite (Fe₃O₄), among others. In addition, aluminum silicate polymorphs minerals commonly found in rocks such as sillimanite, kyanite and andalusite all three represented by molecular formula of Al₂Si₀₅ are also often found in fly ash.

Fly ash can also include calcium sulfate or another source of sulfate ions which may be in the mixture composition of the invention.

The fineness of the fly ash is preferably such that less than about 34% is retained on a 325 mesh sieve (U.S. Series) as tested on ASTM Test Procedure C-311 (2011) (“Sampling and Testing Procedures for Fly Ash as Mineral Admixture for Portland Cement Concrete”). The average particle size of the fly ash materials of the invention is typically less than about 50 microns, preferably less than about 35 microns, more preferably less than about 25 microns, and still more preferably less than about 15 microns. This fly ash is preferably recovered and used dry because of its self-setting nature.

Class C fly ash made from sub-bituminous coal has the following representative composition listed in TABLE E. This fly ash is preferably recovered and used dry because of its self-setting nature.

TABLE E
An example of suitable Class C fly ash

| Component | Proportion (wt. %) |
|---|---|
| SiO₂ | 20-45 |
| Al₂O₂ | 10-30 |
| Fe₂O₃ | 3-15 |
| MgO | 0.5-8 |
| SO₃ | 0.5-5 |
| CaO | 15-60 |
| K₂O | 0.1-4 |
| Na₂O | 0.5-6 |
| Loss on Ignition | 0-5 |

A preferable suitable Class F fly ash has the following composition listed in TABLE F.

TABLE F
An example of suitable Class F fly ash

| Component | Proportion (wt. %) |
|---|---|
| SiO₂ | 50-70 |
| Al₂O₂ | 10-40 |
| Fe₂O₃ | 1-10 |
| MgO | 0.5-3 |
| SO₃ | 0-4 |
| CaO | 0-10 |
| K₂O | 0.1-4 |
| Na₂O | 0.1-6 |
| Loss on Ignition | 0-5 |

Hydraulic Cements

Hydraulic cements for purposes of this invention is a cement that undergoes a chemical setting reaction when it comes in contact with water (hydration) and which will not only set (cure) under water but also forms a water-resistant product.

Hydraulic cements include, but are not limited to, aluminum silicate cements like Portland cement, calcium aluminate cement, calcium sulfoaluminate cement, calcium sulfoaluminoferrite cement, calcium sulfoferrite cement, calcium fluroaluminate cement, strontium aluminate cement, barium aluminate cement, Type-K expansive cement, Type S expansive cement, and sulfobelite cement. Compositions of invention may comprise one or more hydraulic cements added as part of cementitious reactive powder.

Calcium Aluminate Cements

Calcium aluminate cement (CAC) is a hydraulic cement that may form a component of the cementitious reactive powder blend of the invention.

Calcium aluminate cement (CAC) is also commonly referred to as aluminous cement or high alumina cement. Calcium aluminate cements have a high alumina content, preferably about 30-45 wt %. Higher purity calcium aluminate cements are also commercially available in which the alumina content can range as high as about 80 wt %. These higher purity calcium aluminate cements tend to be relatively more expensive. The calcium aluminate cements for use in the invention are finely ground to facilitate entry of the aluminates into the aqueous phase so rapid formation of ettringite and other calcium aluminate hydrates can take place. The surface area of the calcium aluminate cement is preferably greater than about 3,000 cm²/gram, more preferably 3000 to 8000 cm²/gram, and further more preferably about 4,000 to 6,000 cm²/gram as measured by the Blaine surface area method (ASTM C 204).

Several manufacturing methods have emerged to produce calcium aluminate cement worldwide. Typically, the main raw materials used in the manufacturing of calcium aluminate cement are bauxite and limestone. One manufacturing method used for producing calcium aluminate cement is described as follows. The bauxite ore is first crushed and dried, then ground along with limestone. The dry powder comprising of bauxite and limestone is then fed into a rotary kiln. A pulverized low-ash coal is used as fuel in the kiln. Reaction between bauxite and limestone takes place in the kiln and the molten product collects in the lower end of the kiln and pours into a trough set at the bottom. The molten clinker is quenched with water to form granulates of the clinker, which is then conveyed to a stock-pile. This granulate is then ground to the desired fineness to produce the final cement.

Several calcium aluminate compounds are formed during the manufacturing process of calcium aluminate cements. The predominant compound formed is monocalcium aluminate (CaO.Al₂O₃, also referred to as CA), in one type of calcium aluminate cement. In another type of calcium aluminate cement, 12CaO.7Al₂O₃ also referred to as C₁₂A₇ or dodeca calcium hepta aluminate is formed as the primary calcium aluminate reactive phase. Other calcium aluminate and calcium silicate compounds formed in the production of calcium aluminate cements include CaO.2Al₂O₃ also known as CA₂ or calcium dialuminate, dicalcium silicate (2CaO.SiO₂, also known as C₂S), dicalcium alumina silicate (2CaO.Al₂O₃.SiO₂, also known as C₂AS). Several other compounds containing relatively high proportion of iron oxides are also formed. These include calcium ferrites such as CaO.Fe₂O₃ or CF and 2CaO.Fe₂O₃ or C₂F, and calcium alumino-ferrites such as tetracalcium aluminoferrite (4CaO.Al₂O₃.Fe₂O₃ or C₄AF), 6CaO.Al₂O₃.2Fe₂O₃ or C₆AF₂) and 6CaO.2Al₂O₃.Fe₂O₃ or C₆A₂F). Other minor constituents present in the calcium aluminate cement include magnesia (MgO), titania (TiO₂), sulfates and alkalis. The preferred calcium aluminate cements can have one or more of the aforementioned phases. Calcium aluminate cements having monocalcium aluminate (CaO.Al₂O₃ or CA) and/or dodeca calcium hepta aluminate (12CaO.7Al₂O₃ or C₁₂A₇) as predominant phases are particularly preferred. Further, the calcium aluminate phases can be in crystalline form and/or amorphous form. CIMENT FONDU (or HAC FONFU), SECAR 51, and SECAR 71 are some examples of commercially available calcium aluminate cements that have the monocalcium aluminate (CA) as the primary cement phase. TERNAL EV is an example of commercially available calcium aluminate cement that has the dodeca calcium hepta aluminate (12CaO.7Al₂O₃ or C₁₂A₇) as the predominant cement phase.

Compositions of the invention comprise about 2 to 100 parts by weight calcium aluminate cement per 100 pbw of mixture of at least one of calcium sulfoaluminate cement and calcium aluminate cement.

When calcium aluminate cement is used in the present invention, it may be used with calcium sulfoaluminate cement or be used in the absence of calcium sulfoaluminate cement.

Compositions of the present invention using calcium aluminate cement (CAC) in the absence of calcium sulfoaluminate (CSA) cement comprise about 2 to about 100 parts, more preferably about 2.5 to about 80 parts, even more preferably about 5 to about 60 parts by weight (pbw) CAC per 100 pbw of thermally activated aluminosilicate mineral.

To provide a significant degree of dimensional stability and/or shrinkage control to prevent cracking, delamination and other modes of failure, the amount of calcium aluminate cement is preferably about 5 to about 75, more preferably about 10 to 50 parts by weight (pbw) per 100 pbw of a mixture of calcium sulfoaluminate cement and calcium aluminate cement.

Calcium sulfoaluminate (CSA) cements

Calcium sulfoaluminate (CSA) cements are a different class of cements from calcium aluminate cement (CAC) or calcium silicate based hydraulic cements, for example, Portland cement. CSA cements are hydraulic cements based on calcium sulphoaluminate. In contrast, calcium aluminates are the basis of CAC cement and calcium silicates are the basis of Portland cement. Calcium sulfoaluminate cements are made from clinkers that include Ye'elimite (Ca₄(AlO₂)₆SO₄ or C₄A₃Š) as a primary phase. Other major phases present in the CSA may include one or more of the following: dicalcium silicate (C₂S), tetracalcium aluminoferrite (C₄AF), and calcium sulfate (CŠ). The relatively low lime requirement of calcium sulfoaluminate cements compared to Portland cement reduces energy consumption and emission of greenhouse gases from cement production. In fact, calcium sulfoaluminate cements can be manufactured at temperatures approximately 200° C. lower than Portland cement, thus further reducing energy and greenhouse gas emissions. The amount of calcium sulfoaluminate cement that may be used in the compositions of the invention is adjustable based on the amount of active Ye'elimite phase (Ca₄(AlO₂)₆SO₄ or C₄A₃Š) present in the CSA cement. The amount of Ye'elimite phase (Ca₄(AlO₂)₆SO₄ or C₄A₃Š) present in the calcium sulfoaluminate cements useful in this invention is preferably about 20 to about 90 wt % and more preferably 30 to 75 wt %.

When calcium sulfoaluminate (CSA) cement is used in the present invention, it may be used with calcium aluminate cement or be used in the absence of calcium aluminate cement.

Preferably compositions of the present invention comprising the calcium sulfoaluminate cement and the calcium aluminate cement, have an amount of calcium aluminate cement of about 5 to about 75, more preferably about 10 to 50, most preferably about 30 to 45 parts by weight (pbw) per 100 pbw of total calcium sulfoaluminate cement and calcium aluminate cement.

The surface area of the calcium sulfoaluminate cement is preferably greater than about 3,000 cm²/gram, more preferably 3000 to 8000 cm²/gram, and further more preferably about 4,000 to 6,000 cm²/gram as measured by the Blaine surface area method (ASTM C 204).

Compositions of the present invention using calcium sulfoaluminate (CSA) cement in the absence of calcium aluminate cement (CAC) comprise about 2 to about 100 parts, more preferably about 2.5 to about 80 parts, even more preferably about 5 to about 60 parts by weight (pbw) CSA per 100 pbw of thermally activated aluminosilicate mineral.

Calcium Fluoroaluminate Cement

The cementitious reactive powder of the invention may have about 0 to about 20 parts by weight total calcium fluoroaluminate relative to 100 parts by weight fly ash.

Calcium fluoroaluminate has the chemical formula 3CaO.3Al₂O₃.CaF₂. The calcium fluoroaluminate is often produced by mixing lime, bauxite and fluorspar in such an amount that the mineral of the resulting product becomes 3CaO.3Al₂O₃.CaF₂ and burning the resulting mixture at a temperature of about 1,200°-1,400° C. Calcium fluoroaluminate cements may optionally be used in the present invention.

Preferably compositions of the present invention have an absence of calcium fluoroaluminate cement.

Calcium Sulfate

Calcium sulfate may be an ingredient of the geopolymer compositions of the invention. Although calcium sulfate, e.g., calcium sulfate dihydrate will react with water, it does not form a water resistant product and it is not considered to be hydraulic cement for purposes of this invention. Suitable Calcium sulfate types include calcium sulfate dihydrate, calcium sulfate hemihydrate and anhydrous calcium sulfate (anhydrite). These calcium sulfates may be available naturally or produced industrially. Calcium sulfates may synergistically interact with the other fundamental components of the cementitious compositions of the invention and thereby help to minimize material shrinkage while imparting other useful properties to the final material.

Different morphological forms of calcium sulfate can be usefully employed in the present invention. The properties of the geopolymer compositions and composites of of the invention may depend on the type of calcium sulfate used based on its chemical composition, particle size, crystal morphology, and chemical and thermal treatment. Amongst other properties, the setting behavior, rate of strength development, ultimate compressive strength, shrinkage behavior, and cracking resistance of the geopolymer compositions of the invention can be tailored by selecting a proper source of calcium sulfate in the formulation. Thus, the selection of the type of calcium sulfate used is based on the balance of properties sought in the end application.

Particle size and morphology of calcium sulfate may influence the development of early age and ultimate strengths of the geopolymer cementitious compositions of the invention. In general, a smaller particle size of calcium sulfate has been found to provide a more rapid development in early age strength. When it is desirable to have an extremely rapid rate of strength development, the preferred average particle size of calcium sulfate ranges is about 1 to about 100 microns, more preferably about 1 to about 50 microns, and still more preferably about 1 to about 25 microns. Furthermore, calcium sulfates with finer particle size may result in lower material shrinkage.

All three forms of calcium sulfate (primarily hemihydrate, dihydrate and anhydrite) are useful. The most soluble form of calcium sulfate is the hemihydrate, followed by the relatively lower solubility form of the dihydrate, and then followed by the relatively insoluble form of the anhydrite. All three forms are themselves known to set (form matrices of the dihydrate chemical form) in aqueous media under appropriate conditions, and the setting times and compressive strengths of the set forms are known to follow their order of solubility. For example, all other things being equal, employed alone as the sole setting material, the hemihydrate usually has the shortest set times and the anhydrite the longest set times (typically very long set times).

The particle size and morphology of calcium sulfate provides a significant and surprising influence on development of early age strength (less than about 24 hours) of the compositions. The use of a relatively a small particle size calcium sulfate provides a more rapid development in early age compressive strength. The preferred average particle size of calcium sulfate ranges from about 1 to 100 microns, more preferably from about 1 to 50 microns, and most preferably from about 1 to 25 microns.

The amount of calcium sulfate present in proportion to mixture of calcium sulfoaluminate cement and calcium aluminate cement in the composition can moderate potential adverse effects, such as shrinkage, of geopolymer compositions of the invention. The amount of calcium sulfate in geopolymer compositions of the invention is about 2 to about 100, preferably about 5 to about 75, and most preferably about 10 to about 50 parts by weight relative to 100 parts by weight of the mixture of calcium sulfoaluminate cement and calcium aluminate cement.

The calcium sulfate may be added as a separate component or all or part of the calcium sulfate may be provided as part of the calcium aluminate cement or calcium sulfoaluminate cement.

Inorganic Minerals Comprising Alkaline Earth Metal Oxide

In the compositions and methods of the invention the inorganic mineral comprising alkaline earth metal oxide is alkaline earth metal oxide added in addition to the other ingredients. Thus for example, it is in addition to any alkaline earth metal oxide which may naturally be in the fly ash. This added alkaline earth metal oxide is preferably calcium oxide (also known as lime or quicklime), or magnesium oxide, or combinations thereof.

The cementitious reactive powder of the invention may have inorganic mineral comprising alkaline earth metal oxide in an amount of 0.50 to 40, preferably 1 to 30, more preferably 2 to 20 pbw of thermally activated aluminosilicate mineral. The inorganic minerals comprising alkaline earth metal oxide preferred in this invention have an alkaline earth metal oxide content preferably greater than 50 wt %, more preferably greater than 60 wt %, even more preferably greater than 70 wt %, and most preferably greater than 80 wt %, for example greater than 90 wt %.

The preferred alkaline earth metal oxides of the invention include calcium oxide and magnesium oxide. They are typically obtained by calcination of rocks such as limestone, dolomite, and magnesite. The metal oxides can be lightly burned, hard burned, or dead burned. For instance, when magnesium oxide is used as part of the cementitious reactive powder of this invention, it can be lightly burned, moderately burned or dead burned. The inorganic mineral comprising alkaline earth metal oxide powders useful in the present invention can either be predominantly calcium oxide or magnesium oxide. The inorganic mineral comprising alkaline earth metal oxide powders useful in the present invention can also be mixtures of both calcium oxide and magnesium oxide.

Hydraulic cement clinkers such as Portland cement clinker burnt at high temperature and comprising free lime as a major component and calcium silicates, ferro-aluminates, and sulfates as minor components may also be used as the inorganic mineral comprising alkaline earth metal oxide in the present invention. Impurities such as calcium carbonate or magnesium carbonate may also be present along with alkaline earth metal oxide in the material. The particles of inorganic mineral comprising alkaline earth metal oxide may optionally be coated on the surface with organic or inorganic coating materials to tailor reactivity of the particles. Additional functional coatings may be applied on the surface of the particles to impart special properties such as set retardation, water reduction, shrinkage reduction, powder flow aids, etc.

Further, the size of inorganic mineral comprising alkaline earth metal oxide particles may be tailored to control the reactivity of the particles. The median size of the inorganic mineral comprising alkaline earth metal oxide particles is preferably less than 100 microns, more preferably less than 75 microns and most preferably less than 50 microns.

Upon addition of water, the inorganic mineral comprising alkaline earth metal oxide particles undergo a chemical reaction forming either calcium hydroxide or magnesium oxide crystals. Furthermore, while the exact chemical reaction mechanisms are not fully understood at this time, it is the understanding of the inventor that inorganic mineral comprising alkaline earth metal oxides also actively participate in the geopolymeric reactions involving thermally activated aluminosilicate minerals and alkali metal chemical activators. The inorganic mineral comprising alkaline earth metal oxide particles play a multifunctional role in the inorganic geopolymer compositions of the present invention. For instance, they are instrumental in tailoring rheology, setting characteristics, compressive strength, and dimensional movement characteristics of the geopolymer compositions of the present invention.

Portland Cement

The cementitious reactive powder of the invention may have about 0 to about 15 parts by weight total Portland cement relative to 100 parts by weight thermally activated aluminosilicate mineral.

The low cost and widespread availability of the limestone, shales, and other naturally occurring materials make Portland cement one of the lowest-cost materials widely used over the last century throughout the world. As used herein, “Portland cement” is a calcium silicate based hydraulic cement. ASTM C 150 defines Portland cement as “hydraulic cement (cement that not only hardens by reacting with water but also forms a water-resistant product) produced by pulverizing clinkers consisting essentially of hydraulic calcium silicates, usually containing one or more of the forms of calcium sulfate as an interground addition.” As used herein, “clinkers” are nodules (diameters, about 0.2-about 1.0 inch [5-25 mm]) of a sintered material that are produced when a raw mixture of predetermined composition is heated to high temperature.

Preferably there is an absence of Portland cement in compositions of the present invention. It has been found addition of Portland cement to the geopolymer compositions of the present invention increases the shrinkage of the resulting compositions. The magnitude of observed shrinkage increases with increase in the amount of Portland cement in the resulting compositions.

“Naturally-occurring and Non-thermally activated” Pozzolans

The cementitious reactive powder of the invention may have about 0 to about 20 parts by weight total naturally-occurring and non-thermally activated pozzolans relative to 100 parts by weight fly ash.

Preferably there is an absence of naturally-occurring and non-thermally activated pozzolans in compositions of the present invention.

The above-discussed thermally activated aluminosilicate mineral additives have pozzolanic properties. However, in addition to the above-discussed fly ash, other pozzolans can also be included as optional silicate and aluminosilicate mineral additives in the compositions of the invention. ASTM C618 (2008) defines pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.”

Various natural and man-made materials have been referred to as pozzolanic materials possessing pozzolanic properties. Some examples of pozzolanic materials include silica fume, pumice, perlite, diatomaceous earth, finely ground clay, finely ground shale, finely ground slate, finely ground glass, volcanic tuff, trass, and rice husk. All of these pozzolanic materials can be used either singly or in combined form as part of the cementitious reactive powder of the invention.

Alkali Metal Chemical Activators Component B

The Activator Component B comprises alkali metal chemical activator.

In compositions of the invention, alkali metal salts and bases are useful as alkali metal chemical activators to activate the Reactive Powder Component A comprising thermally activated aluminosilicate mineral such as fly ash, aluminate cement, and calcium sulfate. The alkali metal activators of this invention can be added in liquid or solid form. The preferred alkali metal chemical activators of this invention are metal salts of organic acids. The more preferred alkali metal chemical activators of this invention are alkali metal salts of carboxylic acids. Alkali metal hydroxides and alkali metal silicates are some other examples of alkali metal chemical activator of this invention. Alternatively, alkali metal hydroxides and alkali metal silicates can also be used in combination with carboxylic acids such as citric acid to provide chemical activation of cementitious reactive powder blend comprising thermally activated aluminosilicate mineral, aluminate cement, and calcium sulfate. The preferred alkali metal citrates are potassium citrates and sodium citrates and particularly tri-potassium citrate monohydrate, and tri-sodium citrate anhydrous, tri-sodium citrate monohydrate, sodium citrate dibasic sesquihydrate, tri-sodium citrate dihydrate, di-sodium citrate, and mono-sodium citrate. Potassium citrate is the most preferred alkali metal salt activator in this invention.

Employing alkali metal salts of citric acid such as sodium or potassium citrate in combination with the cementitious reactive powder blend comprising thermally activated aluminosilicate mineral comprising Class C fly ash, aluminate cement, and calcium sulfate, provides mixture compositions with relatively good fluidity and which do not stiffen too quickly, after mixing the raw materials at about 68-77° F. (20-25° C.).

The amount of alkali metal salt of citric acid, e.g., potassium citrate or sodium citrate, is about 0.5 to about 10 wt. %, preferably about 1.0 to about 6 wt. %, preferably about 1.25 to about 4 wt. %, more preferably about 1.5 to about 2.5 wt. % and still more preferably about 2 wt % based on 100 parts of the cementitious reactive components (i.e., Cementitious Reactive Powder Component A). Thus, for example, for 100 pounds of cementitious reactive powder, there may be about 1.25 to about 4 total pounds of potassium and/or sodium citrates.

If desired the activator does not contain an alkanolamine. Also, if desired the activator does not contain a phosphate.

Air and Water

Important factors that have been determined to affect the freeze-thaw durability behavior of the material include the air content of the material and the water/cementitious reactive powders ratio.

An important invention objective was to obtain a stable air-void system which is independent of mixing time employed. A stable system is defined as the one where the air content of the material does not vary significantly with change in the mixing time employed. A stable air-void system in turn provides satisfactory freeze-thaw durability performance.

Surprisingly a desired and stable amount of air in the geopolymer composition of the invention is entrained by means of utilizing a combination of various additives including air-entraining agents, defoamers and organic polymers. The other critical factors that affect the air content include the water to cementitious materials ratio, gravel to cementitious materials ratio, mixing time, and mixing methods.

To obtain freeze-thaw durability behavior in accordance to this invention, the air content is about 3% to 20% by volume, more preferably about 4% to 12% by volume, and the most preferably about 4% to 8% by volume.

Unexpectedly, the addition of 0.1 wt % of certain air entraining agents increases the air by close to 1% or more and the addition of 0.01 wt % of certain defoamers decreases the air by close to 1% or more.

The water/cementitious reactive powders ratio in the preferred compositions of the invention is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1.

Freeze-Thaw Durability Component C

The Freeze-Thaw Durability Component C comprises an air-entraining agent and/or surface active organic polymer. The Freeze-Thaw Durability Component C may further comprise a defoaming agent.

Air Entraining Agent

If desired, air entraining agents (also known as foaming agents) are added to the cementitious slurry of the invention to form air bubbles (foam) in situ. Air entraining agents are preferably surfactants used to purposely trap microscopic air bubbles in the concrete. Alternatively, air entraining agents are employed to externally produce foam which is introduced into the mixtures of the compositions of the invention during the mixing operation to reduce the density of the product. Preferably to externally produce foam the air entraining agent (also known as a liquid foaming agent), air and water are mixed to form foam in a suitable foam generating apparatus. A foam stabilizing agent such as polyvinyl alcohol can be added to the foam before the foam is added to the cementitious slurry.

Examples of air entraining/foaming agents include alkyl sulfonates, alkylbenzolfulfonates and alkyl ether sulfate oligomers among others. Details of the general formula for these foaming agents can be found in U.S. Pat. No. 5,643,510 incorporated herein by reference.

An air entraining agent (foaming agent) such as that conforming to standards as set forth in ASTM C 260 “Standard Specification for Air-Entraining Admixtures for Concrete” (Aug. 1, 2006) can be employed. Such air entraining agents are well known to those skilled in the art and are described in the Kosmatka et al “Design and Control of Concrete Mixtures,” Fourteenth Edition, Portland Cement Association, specifically Chapter 8 entitled, “Air Entrained Concrete,” (cited in US Patent Application Publication No. 2007/0079733 A1).

Suitable air entraining (foaming) agents include water soluble salts (usually sodium) of wood resin, vinsol resin, wood rosin, tall oil rosin, or gum rosin; non-ionic surfactants (e.g., such as those commercially available from BASF under the trade name TRITON X-100); sulfonated hydrocarbons; proteinaceous materials; or fatty acids (e.g., tall oil fatty acid) and their esters.

Commercially available air entraining materials include vinsol wood resins, sulfonated hydrocarbons, fatty and resinous acids, aliphatic substituted aryl sulfonates, such as sulfonated lignin salts and numerous other interfacially active materials which normally take the form of anionic or nonionic surface active agents (surfactants), sodium abietate, saturated or unsaturated fatty acids and salts thereof, tensides, alkyl-aryl-sulfonates, phenol ethoxylates, lignosulfonates, resin soaps, sodium hydroxystearate, lauryl sulfate, ABSs (alkylbenzenesulfonates), LASS (linear alkylbenzenesulfonates), alkanesulfonates, polyoxyethylene alkyl(phenyl)ethers, polyoxyethylene alkyl(phenyl)ether sulfate esters or salts thereof, polyoxyethylene alkyl(phenyl)ether phosphate esters or salts thereof, proteinic materials, alkenylsulfosuccinates, alpha-olefinsulfonates, a sodium salt of alpha olefin sulphonate, or sodium lauryl sulphate or sulphonate and mixtures thereof.

Air-entraining agent when present is in an amount of 0.01 to 1, preferably 0.01-0.5, more preferably 0.01-0.2, most preferably 0.05-0.2 weight % based upon the total weight of the Cementitious Reactive Powder Component A (i.e., weight % of total thermally activated aluminosilicate comprising Class C fly ash, aluminate cement, and calcium sulfate). Most preferred dosage of air entraining agent dosage equals about 0.01 to about 0.20 wt % of total Cementitious Reactive Powder Component A.

Defoaming Agents

Defoaming agents can be added to the geopolymer cementitious compositions of the invention to reduce the amount of entrapped air, increase material strength, increase material bond strength to other substrates, and to produce a defect free surface in applications where surface aesthetics is an important criteria. Examples of suitable defoaming agents useful in the geopolymer compositions of the invention include polyethylene oxides, propoxylated amines, polyetheramine, polyethylene glycol, polypropylene glycol, alkoxylates, polyalkoxylate, fatty alcohol alkoxylates, hydrophobic esters, tributyl phosphate, alkyl polyacrylates, silanes, silicones, polysiloxanes, polyether siloxanes, acetylenic diols, tetramethyl decynediol, secondary alcohol ethoxylates, silicone oil, hydrophobic silica, oils (mineral oil, vegetable oil, white oil), waxes (paraffin waxes, ester waxes, fatty alcohol waxes), amides, fatty acids, polyether derivatives of fatty acids, etc., and mixtures thereof.

Preferably the dosage of defoamer equals 0 to about 0.5 wt %, more preferably 0 to about 0.25 wt %, and most preferably 0.01 to about 0.1 wt % of total Cementitious Reactive Powder Component A (i.e., weight % of total thermally activated aluminosilicate comprising Class C fly ash, aluminate cement, and calcium sulfate).

Surface Active Organic Polymer

Surface active organic polymer includes any one or more Organic Rheology Modifiers (also known as Organic Rheology Control Agents), Film-forming polymers, or biopolymers. The Organic Rheology Modifiers could be biopolymers or come from synthetic sources. The Film-forming polymers could be Film Forming Redispersible Polymer Powder or the film forming polymer of a Film Forming Polymer Dispersion. Surface active organic polymers, as their secondary function, also help entrain air in the mixture but may not be as effective as compounds known as air entraining (foaming) agents.

Bio-Polymers

Some of these biopolymers are also known as Thickeners or Viscosity Modifiers. Some also function as film forming polymers. Some, such as methyl cellulose also function as an emulsifier. Naturally occurring biopolymers comprise polysaccharide or amino acid building blocks, and are generally water-soluble. Common examples are starch, cellulose, alginate, egg yolk, agar, arrowroot, carrageenan, collagen, gelatin, guar gum, pectin and xanthan gum. Preferred Bio-polymers include cellulosic ethers and gum-based organic polymers.

Succinoglycans, diutan gum, guar gum, wellan gum, xanthan gums and cellulose ether based organic compounds, are bio-polymers that act as hydrocolloids and rheology control agents. Gum based polymers are selected from the group consisting of galactomannan gums, glucomannan gums, guar gum, locust bean gum, cara gum, hydroxyethyl guar, hydroxypropyl guar, cellulose, hydroxypropyl cellulose, hydroxymethyl cellulose, hydroxyethyl cellulose, and combinations thereof.

Examples of preferred cellulose based organic polymers useful for rheology control in the geopolymer compositions of the present invention include hydroxyethyl-cellulose (HEC), hydroxypropyl-cellulose (HPC), hydroxypropylmethyl-cellulose (HPMC), methyl-cellulose (MC), ethyl-cellulose (EC), methylethyl-cellulose (MEC), carboxymethyl-cellulose(CMC), carboxymethylethyl-cellulose (CMEC), and carboxymethylhydroxyethyl-cellulose(CMHEC).

The biopolymers mentioned above are typically soluble both in cold and/or hot water. These additives also act as water retention agents and thereby minimize material segregation and bleeding in addition to controlling the material rheology.

Organic Rheology Control Agents

As opposed to biopolymers which may be able to control or modify rheology, for purposes of the present specification, Organic Rheology Modifiers (Organic Rheology Control Agents) are defined as those coming from synthetic sources. Some of these Organic Rheology Control Agents are also known as Thickeners. Acrylic-based polymers for Organic Rheology Control Agents are grouped into three general classes: alkali-swellable (or soluble) emulsions (ASE's) hydrophobically modified alkali-swellable emulsions (HASE's) and hydrophobically modified, ethoxylated urethane resins (HEUR's). HASE's are modifications of ASE's following an addition of hydrophobic functional groups. These are commonly known as associative thickeners. In its simplest form, an associative thickener is a water-soluble polymer containing several relatively hydrophobic groups. HEUR's also belong to the category of associative thickeners. But unlike HASE's, HEUR's are nonionic substances and are not dependent on alkali for activation of the thickening mechanism.

Preferred polymers for use as Organic Rheology Control Agents and thickeners in the geopolymer compositions of the invention are selected from the group consisting of polyacryl amides, alkali-swellable acrylic polymers, associative acrylic polymers, acrylic/acrylamide copolymers, hydrophobically modified alkali-swellable polymers, and highly water-swellable organic polymers.

For example, ACULYN 22 rheology modifier is an anionic hydrophobically modified alkali-soluble acrylic polymer emulsion (HASE) available from Dow Chemical. HASE polymers are synthesized from an acid/acrylate copolymer backbone and a monomer that connects the hydrophobic groups as side chains. The polymer is made through emulsion polymerization. ACULYN 22 is synthesized from acrylic acid, acrylate esters and a steareth-20 methacrylate ester.

Both associative and non-associative types of organic rheology control agents and thickeners can be usefully employed in the geopolymer compositions of the invention.

The organic rheology control agents and thickeners mentioned above are soluble both in cold and/or hot water. These additives also act as water retention agents and thereby minimize material segregation and bleeding in addition to controlling the material rheology.

Film-Forming Polymer Additives

Film forming polymers are polymers which produce a physical, continuous and flexible film. They are available as polymer dispersions or as redispersible powders. Preferred film forming polymer dispersions are latex dispersions. Preferred film forming redispersible polymer powders are latex powders. These polymer powders are water-redispersible and produced by spray-drying of aqueous polymer dispersions (latex). The polymer powders are typically made by spray drying latex dispersions (emulsions). In the field film forming redispersible polymer powders are preferred for ease of use.

Latex is an emulsion polymer. Latex is a water based polymer dispersion, widely used in industrial applications. Latex is a stable dispersion (colloidal emulsion) of polymer microparticles in an aqueous medium. Thus, it is a suspension/dispersion of rubber or plastic polymer microparticles in water. Latexes may be natural or synthetic.

The latex is preferably made from a pure acrylic, a styrene rubber, a styrene butadiene rubber, a styrene acrylic, a vinyl acrylic or an acrylated ethylene vinyl acetate copolymer, and is more preferably a pure acrylic. Preferably latex polymer is derived from at least one acrylic monomer selected from the group consisting of acrylic acid, acrylic acid esters, methacrylic acid, and methacrylic acid esters. For example, the monomers preferably employed in emulsion polymerization include such monomers as methyl acrylate, ethyl acrylate, methyl methacrylate, butyl acrylate, 2-ethyl hexyl acrylate, other acrylates, methacrylates and their blends, acrylic acid, methacrylic acid, styrene, vinyl toluene, vinyl acetate, vinyl esters of higher carboxylic acids than acetic acid, e.g. vinyl versatate, acrylonitrile, acrylamide, butadiene, ethylene, vinyl chloride and the like, and mixtures thereof. For example, a latex polymer can be a butyl acrylate/methyl methacrylate copolymer or a 2-ethylhexyl acrylate/methyl methacrylate copolymer. Preferably, the latex polymer is further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C4-C8 conjugated dienes.

Vinyl acetate ethylene (VAE) emulsions are based on the copolymerization of vinyl acetate and ethylene, in which the vinyl acetate content can range between 60 and 95 percent, and the ethylene content ranges between 5 and 40 percent of the total formulation. This product should not be confused with the ethylene vinyl acetate (EVA) copolymers, in which the vinyl acetate generally ranges in composition from 10 to 40 percent, and ethylene can vary between 60 and 90 percent of the formulation. VAEs are water-based emulsions and these emulsions can be dried to form redispersible powders, whereas EVAs are solid materials used for hot-melt and plastic molding applications.

The film-forming polymer can be chosen from dispersions of polymer particles which may include: (meth)acrylics; vinyls; oil-modified polymers; polyesters; polyurethanes; polyamides; chlorinated polyolefins; and, mixtures or copolymers thereof, for example, vinyl acetate ethylene. Further, the polymers should typically have a glass transition temperature (Tg) of from −40° to 70° C. The Tg of a polymer is most commonly determined by differential scanning calorimetry (DSC). The Tg is the temperature at which there is a ‘sudden’ increase in the specific heat (Cp). This is manifested by a shift in the baseline of the DSC curve. The International Confederation of Thermal Analysis proposes an evaluation procedure to be used to determine the Tg. According to this procedure two regression lines R1 and R2 are applied to the DSC curve: the regression line before the event (R1) and the regression line at the inflection point (R2). These two lines define the glass transition temperature (Tg) as the intersection between R1 and R2. It should be noted that the values for the Tg obtained by DSC are dependent on the heating rate chosen during the experiment. Generally the heating rate used by DSC measurements is 5° C./min.

As preferred polymers may be mentioned: i) pure acrylate copolymers obtainable as the polymerization product of a plurality of acrylic monomers such as (meth)acrylic acid, (meth)acrylic monomers containing a hydroxyl group, (meth)acrylic acid esters and (meth)acrylonitrile; ii) styrene-acrylate copolymers obtainable as the polymerization product of a monomer mixture comprising styrene and/or substituted styrene in an amount of up to 100 wt. %, preferably of from 30 to 90 wt. % and more preferably of from 40 to 80 wt. %, based on total monomers, and one or more acrylic monomers; and, such as (meth)acrylic acid, (meth)acrylic monomers containing a hydroxyl group, (meth)acrylic acid esters and (meth)acrylonitrile; and, iii) ethylene vinyl acetate copolymers obtainable as the polymerization product of vinyl acetate, ethylene, and optionally other co-monomers.

The polymers can be prepared and used in bulk, powdered form: such powders would be re-dispersed in the water during the formation of the second component. ACRONAL S 430 P and ACRONAL S 695 P (BASF Aktiengesellschaft) are examples of a suitable commercial, re-dispersible styrene-acrylate copolymer powder.

In the alternative the polymers are directly provided as a dispersion in the water based medium, which dispersion is then mixed with additional water and other additives. Such dispersions may be provided using known commercial products such as: STYROPOR P555 (styrene homopolymer available from BASF Aktiengesellschaft); for styrene butadiene copolymers, LIPATON SB 3040, LIPATON SB 2740 (Polymer Latex GmBH), STYROLUX 684 D (BASF Aktiengesellschaft) and, SYNTHOMER 20W20 (Synthomer Chemie); SYNTHOMER VL 10286 and SYNTHOMER 9024 (styrene/butadiene/acrylonitrile terpolymer, Synthomer Chemie); for styrene acrylate copolymers, ALBERDINGK H 595, ALBERDINGK AS 6002 (both Alberdingk Boley), RHODOPAS DS 913 (Rhodia, now Solvay), ACRONAL 290D, ACRONAL S 400, ACRONAL DS 5011 (BASF Aktiengesellschaft), VINNAPAS SAF 54 (Wacker Polymer Systems), MOWILITH LDM 6159 (Celanese) and LIPATON AE 4620 (Polymer Latex GmBH); and, B60A (pure acrylate dispersion available from Rohm & Haas). Other exemplary commercially available latex polymers include: AIRFLEX EF811 (available from Air Products); EPS 2505 (available from EPS/CCA); and, NEOCAR 2300, NEOCAR 820 and NEOCAR 2535 (available from Dow Chemical Co.).

Alternatively, the aqueous dispersions may be provided by polymerizing appropriate monomer mixtures as will be described herein below. P. A. Lovell, M. S. El-Aasser (Editors), “Emulsion Polymerization and Emulsion Polymers”, John Wiley and Sons, Chichester, UK, 1997 is herein incorporated by reference. The monomer mixture should generally comprise at least one unsaturated monomer selected from the group consisting of: (meth)acrylonitrile; alkyl (meth)acrylate esters; (meth)acrylic acids; vinyl esters; and, vinyl monomers.

Suitable alkyl esters of acrylic acid and methacrylic acid are those derived from C1 to C14 alcohols and thereby include as non-limiting examples: methyl (meth)acrylate; ethyl (meth)acrylate; isopropyl (meth)acrylate; butyl (meth)acrylate; isobutyl (meth)acrylate; n-pentyl (meth)acrylate; neopentyl (meth)acrylate; cyclohexyl (meth)acrylate; 2-hexyl (meth)acrylate; 2-ethylhexyl (meth)acrylate; isobornyl (meth)acrylate; 2-hydroxyethyl (meth)acrylate, 3-hydroxypropyl (meth)acrylate, 4-hydroxybutyl (meth)acrylate, and epsilon-caprolactone adducts thereof; and, di(meth)acrylate esters of alkane diols such as 1,6-hexane diol diacrylate.

Suitable vinyl esters include vinyl acetate, vinyl propionate, vinyl versatate and vinyl laurate. Suitable vinyl comonomers include: ethylene; propene; butene; iso-butene; 1,3-butadiene; isoprene; styrene; alpha-methyl styrene; t-butyl styrene; vinyl toluene; divinyl benzene; heterocyclic vinyl compounds; and, vinyl halides such as chloroprene. Preferably the vinyl comonomers include ethylene, styrene, butadiene and isoprene.

The monomer mixture may comprise a carbonyl monomer that is a mono-olefinically unsaturated monomer having an aldehyde group or a ketone group. The mono-olefinic unsaturation in the carbonyl monomers of this invention is typically provided by (meth)acrylate, (meth)acrylamide, styryl or vinyl functionalities. Preferably the carbonyl monomer is selected from the group consisting of: acrolein; methacrolein; vinyl methyl ketone; vinyl ethyl ketone; vinyl isobutyl ketone; vinyl amyl ketone; acetoacetoxy esters of hydroxyalkyl (meth)acrylates; diacetoneacrylamide (DAAM); diacetone(meth)acrylamide; formylstyrol; diacetone (meth)acrylate; acetonyl acrylate; 2-hydroxypropyl acrylate-acetyl acetate; 1,4-butanediol acrylate acetylacetate; and, mixtures thereof.

Examples of suitable film forming homopolymers and copolymers are vinyl acetate homopolymers, copolymers of vinyl acetate with ethylene, copolymers of vinyl acetate with ethylene and one or more further vinyl esters, copolymers of vinyl acetate with ethylene and acrylic esters, copolymers of vinyl acetate with ethylene and vinyl chloride, styrene-acrylic ester copolymers, styrene-1,3-butadiene copolymers. Preference is given to vinyl acetate homopolymers; copolymers of vinyl acetate with from 1 to 40% by weight of ethylene; copolymers of vinyl acetate with from 1 to 40% by weight of ethylene and from 1 to 50% by weight of one or more further comonomers from the group consisting of vinyl esters having from 1 to 15 carbon atoms in the carboxylic acid radical, e.g. vinyl propionate, vinyl laurate, vinyl esters of alpha-branched carboxylic acids having from 9 to 13 carbon atoms; copolymers of vinyl acetate, from 1 to 40% by weight of ethylene and preferably 1 to 60% by weight of acrylic esters of unbranched or branched alcohols having from 1 to 15 carbon atoms, in particular n-butyl acrylate or 2-ethylhexyl acrylate; and copolymers comprising from 30 to 75% by weight of vinyl acetate, from 1 to 30% by weight of vinyl laurate or the vinyl ester of an alpha-branched carboxylic acid having from 9 to 13 carbon atoms, and from 1 to 30% by weight of acrylic esters of unbranched or branched alcohols having from 1 to 15 carbon atoms, in particular n-butyl acrylate or 2-ethylhexyl acrylate, and further comprising from 1 to 40% by weight of ethylene; copolymers comprising vinyl acetate, from 1 to 40% by weight of ethylene and from 1 to 60% by weight of vinyl chloride; where the polymers may further comprise the above-mentioned auxiliary monomers in the amounts specified and the percentages by weight in each case add up to 100% by weight.

### Other Additives

In the invention, other additives not considered cementitious reactive powder may be incorporated into the slurry and overall geopolymeric cementitious composition. Such other additives, for example, superplasticizers (water reducing agents), set accelerating agents, set retarding agents, air-entraining agents, foaming agents, wetting agents, shrinkage control agents, viscosity modifying agents (thickeners), film-forming redispersible polymer powders, film-forming polymer dispersions, set control agents, efflorescence control (suppression) agents, coloring agents, corrosion control agents, alkali-silica reaction reducing admixtures, discrete reinforcing fibers, and internal curing agents. Other additives may include fillers, such as one or more of sand and/or other aggregates, lightweight fillers, mineral fillers, etc.

Superplasticizer

Superplasticizers (water reducing agents) are preferably used in the compositions of the invention. They may be added in the dry form or in the form of a solution. Superplasticizers help to reduce water demand of the mixture. Examples of superplasticizers include polynaphthalene sulfonates, polyacrylates, polycarboxylates, polyether polycarboxylates, lignosulfonates, melamine sulfonates, caseins, and the like.

Preferably the superplasticizer is a carboxylated plasticizer material. Thus, superplasticizers based on polycarboxylate polyether chemistry are the most preferred water reducing chemical admixture of the geopolymeric cementitious compositions of the invention. Polycarboxylate polyether superplasticizers are the most preferred since they facilitate accomplishment of the various objectives of this invention as mentioned earlier.

Depending upon the type of superplasticizer used, the weight ratio of the superplasticizer (on dry powder basis) to the cementitious reactive powders preferably will be about 5 wt % or less, preferably about 2 wt. % or less, preferably about 0.1 to about 1 wt. %.

Fillers—Fine Aggregate, Coarse Aggregate, Inorganic Mineral Fillers and Lightweight Fillers

One or more fillers such as fine aggregate, coarse aggregate, inorganic mineral fillers, and lightweight fillers may be used as a component in compositions of the invention. These fillers are not pozzolans or thermally activated aluminosilicate minerals.

Fine aggregates can be added to the geopolymer compositions in the invention without affecting the properties to increase the yield of the material. An example of fine aggregate is Sand. Sand is defined as an inorganic rock material with an average particle size of less than about 4.75 mm (0.195 inches). The sand used in this invention preferably meet the standard specifications of the ASTM C33 standard. Preferably the sand has a mean particle size of 0.1 mm to about 3 mm. More preferably the sand has a mean particle size of 0.2 mm to about 2 mm. Most preferably the sand has a mean particle size about 0.3 to about 1 mm. Examples of preferable fine sand for use in this invention include QUIKRETE FINE No. 1961 and UNIMIN 5030 having a predominant size range of US sieve number #70-#30 (0.2-0.6 mm). The fine aggregate used in this invention meet the ASTM C33 standard performance.

Inorganic mineral fillers are dolomite, limestone, calcium carbonate, ground clay, shale, slate, mica and talc. Generally they have a fine particle size with preferably average particle diameter of less than about 100 microns, preferably less than about 50 microns, and more preferably less than about 25 microns in the compositions of the invention. Smectite clays and palygorskite and their mixtures are not considered inorganic mineral fillers in this invention.

Coarse aggregates can be added to the geopolymer compositions without it affecting any of the properties to increase the yield of the material. Coarse aggregate is defined as an inorganic rock material with an average particle size at least 4.75 mm (0.195 inches), for example ¼″ to 1½ in.″ (0.64 to 3.81 cm). Aggregate with size larger than 1-½″ (3.81 cm) may also be used in some applications for example concrete pavement. The particle shape and texture of the coarse aggregate used can be angular, rough-textured, elongated, rounded or smooth or a combination of these. Preferably coarse aggregate are made of minerals such as granite, basalt, quartz, riolite, andesite, tuff, pumice, limestone, dolomite, sandstone, marble, chert, flint, greywacke, slate, and/or gneiss. Coarse aggregate useful in the invention as listed in TABLE A-2 and D meets specifications set out in ASTM C33 (2011) and AASHTO M6/M80 (2008) standards. Gravel is a typical coarse aggregate.

Lightweight fillers have a specific gravity of less than about 1.5, preferably less than about 1, more preferably less than about 0.75, and still more preferably less than about 0.5. If desired the specific gravity of lightweight fillers is less than about 0.3, more preferably less than about 0.2 and most preferably less than about 0.1. In contrast, inorganic mineral filler preferably has a specific gravity above about 2.0. Examples of useful lightweight fillers include pumice, vermiculite, expanded forms of clay, shale, slate and perlite, scoria, expanded slag, cinders, glass microspheres, synthetic ceramic microspheres, hollow ceramic microspheres, lightweight polystyrene beads, plastic hollow microspheres, expanded plastic beads, and the like. Expanded plastic beads and hollow plastic spheres when used in the composition of the invention are employed in very small quantity on a weight basis owing to their extremely low specific gravity.

When lightweight fillers are utilized to reduce the weight of the material, they may be employed at filler to cementitious materials (reactive powder) ratio of about 0 to about 2, preferably about 0.01 to about 1, preferably about 0.02 to about 0.75. One or more types of lightweight fillers may be employed in the geopolymer compositions of the invention.

Yield is defined as the total volume of slurry in cubic feet, obtained from 50 pounds of dry material consisting of cementitious materials and additives (i.e., 50 pounds mixture of cementitious materials and additives), when mixed with fine aggregate (when present), coarse aggregate (when present), lightweight filler (when present), inorganic mineral filler (when present) and water.

For the full density compositions of the present invention, the yield of 50 pounds of dry material consisting of cementitious materials and additives, when mixed with fine aggregate, coarse aggregate, and water is preferably greater than 0.75 cubic feet, more preferably greater than 1.5 cubic feet, even more preferably greater than 2.0 cubic feet, and most preferably greater than 2.5 cubic feet.

When lightweight fillers are employed as part of the composition, the yield of 50 pounds of dry material consisting of cementitious materials and additives, when mixed with fine aggregate (when present), coarse aggregate (when present), lightweight filler and water is preferably greater than 3 cubic feet, more preferably greater than 4.5 cubic feet, even more preferably greater than 6 cubic feet, and most preferably greater than 7.5 cubic feet.

Compositions of the present invention may be free of added fillers.

Preferably compositions of the present invention are free of biosourced fillers. Biosourced fillers are fillers typically of animal or plant origin. When it is of plant origin, the biosourced filler is essentially composed of cellulose, hemicellulose and/or lignin. The biosourced filler typically comprises at least one component—fibers, fibrils, dusts, powders, chips, the component originating from at least a part of at least one plant raw material, in at least a particulate form. This plant raw material typically being for example any one or more of hemp, flax, cereal straw, oat, rice, maize, canola seed, maize, sorghum, flax shives, miscanthus (elephant grass), rice, sugar cane, sunflower, kenaf, coconut, olive stones, bamboo, wood (e.g. wood pellets, for example spruce chippings), sisal, cork (beads) or mixtures thereof.

Preferably the compositions of the invention have an absence of borax.

Inorganic Rheology Control Agents

The geopolymer cementitious compositions of the invention may also include inorganic rheology control agents belonging to the family of phyllosilicates. Examples of inorganic rheology control agents particularly useful in the geopolymer compositions of invention include palygorskite, sepiolite, smectites, kaolinites, and illite. Particularly useful smectite clays that may be used in the present invention include hectorite, saponite, and montmorillonite. Different varieties of bentonite clays both natural and chemically treated may also be used to control rheology of the compositions of the present invention. These additives also act as water retention agents and thereby minimize material segregation and bleeding. The inorganic rheology control agents may be added in the absence of or in combination with the organic rheology control agents.

Efflorescence Suppression Agent

Water repelling agents such as silanes, silicones, siloxanes, stearates may be added to the cementitious compositions of the invention to reduce efflorescence potential of the material. Selected examples of useful efflorescence suppression agents include octyltriethoxy silane, potassium methyl siliconate, calcium stearate, butyl stearate, polymer stearates. These efflorescence control agents reduce the transport of the water within the hardened material and thereby minimize migration of salts and other soluble chemicals that can potentially cause efflorescence. Excessive efflorescence can lead to poor aesthetics, material disruption and damage from expansive reactions occurring due to salt accumulation and salt hydration, and reduction in bond strength with other substrates and surface coatings.

Set Retarders

Organic compounds such as hydroxylated carboxylic acids, carbohydrates, sugars, and starches are the preferred retarders of the invention. Organic acids such as citric acid, tartaric acid, malic acid, gluconic acid, succinic acid, glycolic acid, malonic acid, butyric acid, malic acid, fumaric acid, formic acid, glutamic acid, pentanoic acid, glutaric acid, gluconic acid, tartronic acid, mucic acid, tridydroxy benzoic acid, etc. are useful as set retarders in the dimensionally stable geopolymer cementitious compositions s of the invention. Sodium gluconate is also useful as an organic set retarder in the present invention.

Preferably inorganic acid based retarders of the type borates or boric acid are not employed in compositions of the present invention because they have been found to hinder mix rheology, cause excessive efflorescence, and reduce material bond strength to other substrates.

Other Optional Set-Control Agents

Other optional set control chemical additives include a sodium carbonate, potassium carbonate, calcium nitrate, calcium nitrite, calcium formate, calcium acetate, calcium chloride, lithium carbonate, lithium nitrate, lithium nitrite, aluminum sulfate, sodium aluminate, alkanolamines, polyphosphates, and the like. These additives when included as a part of the formulation may also influence rheology of the geopolymer compositions of the invention in addition to affecting their setting behavior.

Optional Materials, Fibers, and Scrims

Other optional materials and additives may be included in geopolymer compositions of the invention. These include at least one member selected from the group consisting of corrosion control agents, wetting agents, colorants and/or pigments, discrete fibers, long and continuous fibers and reinforcement, textile reinforcement, polyvinyl alcohol fibers, glass fibers, and/or other discrete reinforcing fibers.

Discrete reinforcing fibers of different types may also be included in the geopolymer compositions of the invention. Scrims made of materials such as polymer-coated glass fibers and polymeric materials such as polypropylene, polyethylene and nylon can be used to reinforce the cement-based precast products depending upon their function and application.

Preferably the geopolymer compositions of the invention have an absence of cement kiln dust. Cement kiln dust (CKD) is created in the kiln during the production of cement clinker. The dust is a particulate mixture of partially calcined and unreacted raw feed, clinker dust and ash, enriched with alkali sulfates, halides and other volatiles. These particulates are captured by the exhaust gases and collected in particulate matter control devices such as cyclones, baghouses and electrostatic precipitators. CKD consists primarily of calcium carbonate and silicon dioxide which is similar to the cement kiln raw feed, but the amount of alkalies, chloride and sulfate is usually considerably higher in the dust. CKD from three different types of operations: long-wet, long-dry, and alkali by-pass with precalcined have various chemical and physical traits. CKD generated from long-wet and long-dry kilns is composed of partially calcined kiln feed fines enriched with alkali sulfates and chlorides. The dust collected from the alkali by-pass of pre-calcined kilns tends to be coarser, more calcined, and also concentrated with alkali volatiles. However, the alkali by-pass process contains the highest amount by weight of calcium oxide and lowest loss on ignition (LOI). TABLE AA from Adaska et al., Beneficial Uses of Cement Kiln Dust, presented at 2008 IEEE/PCA 50th Cement Industry Technical Conf., Miami, Fla., May 19-22, 2008, provides the composition breakdown for the three different types of operation and includes a preferably chemical composition for Type I Portland cement for comparison.

TABLE G
Composition of CKD from Different Operation Sources

| | | | Alkali | Preferably |
|---|---|---|---|---|
| | Long-wet | Long-dry | by-pass from | Type I |
| | kiln | kiln | preheater/ | Portland |
| | (% by | (% by | pre-calciner | cement |
| Constituent | weight) | weight) | (% by weight) | (% by weight) |
| SiO₂ | 15.02 | 9.64 | 15.23 | 20.5 |
| Al₂O₃ | 3.85 | 3.39 | 3.07 | 5.4 |
| Fe₂O₃ | 1.88 | 1.10 | 2.00 | 2.6 |
| CaO | 41.01 | 44.91 | 61.28 | 63.9 |
| MgO | 1.47 | 1.29 | 2.13 | 2.1 |
| SO₃ | 6.27 | 6.74 | 8.67 | 3.0 |
| K₂O | 2.57 | 2.40 | 2.51 | <1 |
| Loss on | 25.78 | 30.24 | 4.48 | 0-3 |
| Ignition | | | | |
| (LOI) | | | | |
| Free lime | 0.85 | 0.52 | 27.18 | <2 |
| (CaO) | | | | |

There are impurities in the CKD which tend to interfere with the geopolymeric reactions of this invention. Further, the composition of CKD tends be highly variable. The free lime in the CKD may be considered as added lime but due to the presence of other impurities in the CKD and variability in the CKD composition, the use of CKD is not recommended in the present invention. Thus, CKD is preferably absent.

Preferably the compositions of the invention have an absence of the following organic particles: coffee grounds particles, leaf powder particles, starch particles, ground leaf particles, and cork powder.

Properties of the compositions of the Invention

Preferably the compositions of the present invention have compressive strengths after 100 freeze-thaw cycles, typically after 300 freeze-thaw cycles of greater than 3000 psi, more preferably the compressive strengths are greater than 5000 psi and most preferably greater than 7000 psi.

The compositions of the present invention have little or no loss in mechanical performance and durability, as demonstrated per ASTM C666/C66M-15 by the measured parameter relative dynamic modulus, for up to 100 freeze-thaw cycles, typically up to 300 freeze-thaw cycles, preferably up to 600 freeze-thaw cycles, more preferably up to 900 freeze-thaw cycles, and most preferably up to 1200 freeze-thaw cycles.

Compositions of the present invention have freeze-thaw durability performance per ASTM C666/C66M-15 as indicated by relative dynamic modulus after a number of freeze-thaw cycles. In particular, for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles the relative dynamic modulus greater than 80% for the above freeze-thaw cycles (e.g., the relative dynamic modulus greater than 80% for at least 300 cycles), preferably greater than 85% for the above freeze-thaw cycles, more preferably greater than 90% for the above freeze-thaw cycles, furthermore preferably greater than 95% for the above freeze-thaw cycles, and most preferably greater than 95% for the above freeze-thaw cycles.

The initial dynamic elastic modulus (prior to initiation of freeze-thaw cycles) and dynamic elastic modulus after 100 freeze-thaw cycles, typically after 300 freeze-thaw cycles, is preferably greater than 20 GPa, more preferably greater than 25 GPa, and most preferably greater than 30 GPa.

The relative dynamic modulus after 100 freeze-thaw cycles, typically after 300 freeze-thaw cycles, is preferably equal or greater than 100.

Also, the compositions of the invention achieve a desirable Durability Factor as explained above, wherein the composition has a Durability Factor (DF) measured according to ASTM C666/C666m—15 greater than 85%, preferably greater than 90%, more preferably greater than 95%, and most preferably equal or greater than 100% for 100 freeze-thaw cycles, typically for 300 freeze-thaw cycles.

The long term free drying shrinkage of compositions of the invention may be less than about 0.3%, preferably less than about 0.2%, and more preferably less than about 0.1%, and most preferably less than about 0.05% (measured after initial set). Compositions of the invention may show a net expansion, preferably about 0 to 2.0%, more preferably about 0 to 1.0%, and most preferably about 0 to 0.5%.

The invention also exhibits superior compressive strength than regular Portland cement concrete. For example, the 24-hour compressive strength may exceed about 1000 psi, more preferably exceeding about 2000 psi, and most preferably exceeding about 3000 psi. The 7-day compressive strength may exceed about 2000 psi, more preferably exceeding about 3000 psi, and most preferably exceeding about 4000 psi. The 28-day compressive strength may exceed about 3000 psi, more preferably exceeding about 5000 psi, and most preferably exceeding about 7000 psi.

Preferably the geopolymer compositions of this invention set faster than regular Portland cement concrete mixtures. The final setting time for a geopolymer composition of this invention is preferably less than 360 minutes, more preferably less than 240 minutes, and most preferably less than 180 minutes. Some compositions of this invention are extremely rapid setting having a final set time of less than 60 minutes.

The compositions of the present invention have superior salt-scaling resistance per ASTM C672/C672M-12 Standard Test Method for Scaling Resistance of Concrete Surfaces Exposed to Deicing Chemicals, ASTM, published 2012. When tested according to this ASTM C672/C672M-12 salt scaling test the compositions have as indicated by weight loss less than 1% after 25 freeze-thaw cycles, more preferably after 50 freeze-thaw cycles, and most preferably after 75 freeze-thaw cycles when subjected to solutions of sodium chloride and solutions of calcium chloride.

While separately discussed above, each of the preferred geopolymeric compositions and mixtures of the invention has at least one, and can have a combination of two or more of the above mentioned distinctive advantages (as well as those apparent from the further discussion, examples and data herein) relative to prior art geopolymeric cementitious compositions.

The compositions of the invention are highly environmentally sustainable, utilizing fly ash—a post industrial waste as a primary raw material source. This significantly reduces the life cycle carbon footprint and the life cycle embodied energy of the manufactured product.

Uses of Composition of the Invention

The compositions of the invention have many uses. They can be used where other cementitious materials are used, particularly applications where freeze-thaw stability and compressive strength are important or necessary. For example, in various concrete product applications including structural concrete panels for floors, slabs, and walls, wall and floor underlayment for installation of floor-finish materials such as ceramic tiles, natural stones, vinyl tiles, vinyl composition tiles (VCTs), and carpet, highway overlays and bridge repair, sidewalks and other slabs-on-ground, repair materials for wall, floors and ceiling bonding mortars, plasters, surfacing materials, roofing materials, exterior stucco and finish plasters, self-leveling topping and capping underlayments, guniting and shotcrete (both dry mix shotcrete and wet mix shotcrete) which are sprayed products for stabilization of earth and rocks in foundations, mountain slopes and mines, patching repair mortars for filling and smoothing cracks, holes and other uneven surfaces, statuary and murals for interior and exterior applications, as well as pavement materials for roads, bridge decks and other traffic and weight bearing surfaces. The geopolymer compositions of the invention can be used instead of regular Portland cement concrete in both new construction as well as repair and rehabilitation of old concrete.

Other examples include uses for precast concrete articles, as well as building products such as cementitious boards, masonry blocks, bricks, and pavers with excellent moisture durability. In some applications, such precast concrete products such as cement boards are preferably made under conditions which provide setting times appropriate for pouring into a stationary or moving form or over a continuously moving belt.

The geopolymer compositions of the invention can be used with different fillers and additives including foaming agents and air entraining agents for adding air in specific proportions to make lightweight cementitious products, including precast construction elements, construction repair products, traffic bearing structures such as road compositions with good expansion properties and no shrinkage.

A most preferred use of the composition is for road patching to repair a pavement or road defect. Typical defects are potholes, sinkholes, or cracks. When used as road patch the slurry is placed into the pavement or road defect and cures to form a patch having good freeze-thaw resistance. Thus, it resists cracking when exposed to multiple freeze-thaw cycles where temperature cycles below 32° F. (freeze) and above 32° F. (thaw).

### EXAMPLES

The following examples investigated the performance of the geopolymeric formulations comprising cementitious compositions fly ash, calcium sulfoaluminate cement, calcium aluminate cement, and calcium sulfates. The mixes were activated with potassium citrate and contained varying amounts of sand or varying amounts of sand and aggregate. All mixtures contained calcium sulfoaluminate cement and/or calcium aluminate cements. All mixes contained at least one of the three different types of calcium sulfates: calcium sulfate dihydrate, calcium sulfate hemihydrate, and anhydrous calcium sulfate (anhydrite).

The compressive strengths in these examples, unless otherwise specified, were measured according to ASTM C109—Standard Test Method for Compressive Strength of Hydraulic Cement Mortars (Using 2-in. or [50-mm] Cube Specimens).

Unless otherwise indicated, freeze-thaw durability performance of all the geopolymeric cementitious compositions of the examples in the present specification were tested based on ASTM C666/C 666M-15—Procedure A—Standard Test Method for Resistance of Concrete to Rapid Freezing and Thawing, published 2015.

Unless otherwise indicated, a high shear mixer was employed for the mixes of the following examples and the mixing time was 4 minutes.

Unless otherwise indicated, the mixes of the examples were activated with potassium citrate.

The superplasticizer used for the examples of this specification was BASF CASTAMENT FS 20 polymerization product based on polyethylene glycol. EP 2598457 describes it as an anionic dispersant. EP 2616407 describes it as a polyether polycarboxylate.

The rheology modifier used for the examples of this specification was MOMENTIVE AXILAT RH 100 XP which is Succinoglycan. This is an exopolysaccharide biopolymer. Exopolysaccharides are high-molecular-weight polymers composed of sugar residues and are secreted by a microorganism into the surrounding environment.

Another rheology modifier used in the examples is AN BERMCOLL E 230X. It is a cellulose ether based thixotropic agent.

The organic polymer (which is a species of a film forming surface active polymer) used for the examples of this specification was BASF ACRONAL S 695 P. BASF ACRONAL S 695 P is a re-dispersible polymer powder mainly used to modify inorganic binders. In the tables of compositions for the examples it is listed as “Polymer”. It is a copolymer of butyl acrylate and styrene in powder form. US published patent app. no. 2004/0259022, para. [0126] discloses ACRONAL S 695 P is a styrene/butyl acrylate(meth)acrylamide emulsion copolymer available from BASF.

Unless otherwise indicated, the defoamer was SURFYNOL 500S from Air Products. Unless otherwise indicated, the air-entraining agent was VINSOL NVX resin from Pinova.

In all of the examples, unless otherwise indicated, the fly ash was Class C Fly Ash from Campbell Power Plant, West Olive, Mich. This fly ash had an average particle size of about 4 microns. The measured Blaine fineness of the fly ash was about 4300 cm²/g. The oxide composition of the Class C fly ash used in these examples is shown in TABLE. L.

Unless otherwise indicated, the calcium aluminate cement used in the examples of this invention was TERNAL EV available from Kerneos Inc. This cement had a mean particle size of about 29 microns. The oxide composition of TERNAL EV is shown in TABLE L. The main calcium aluminate phase in TERNAL EV is dodecacalcium hepta-aluminate (12CaO.7Al₂O₃ or C₁₂A₇).

Unless otherwise indicated, the calcium sulfoaluminate cement used in the examples of this invention was FASTROCK 500 available from the CTS Company. This cement had a mean particle size of about 11 microns. The oxide compositions of FASTROCK 500 is shown in TABLE L.

USG HYDROCAL C-Base used in some of the examples is available from United States Gypsum Company. HYDROCAL C-Base is an alpha morphological form of calcium sulfate hemihydrate having blocky crystal microstructure and lower water demand. The USG HIYDROCAL C-Base had a mean particle size of about 17 microns.

The anhydrous calcium sulfate (anhydrite) included in some of the examples was SNOW WHITE filler available from United States Gypsum Company. The USG SNOW WHITE filler is an insoluble form of anhydrite produced by high temperature thermal treatment of calcium sulfate, preferably gypsum. it has a very low level of chemically combined moisture, preferably around 0.35%. The mean particle size of the USG SNOW WHITE filler is about 7 microns.

USG TERRA ALBA is a fine-grained calcium sulfate dihydrate available from United States Gypsum Company. The mean particle size of USG TERRA ALBA is about 13 microns.

The calcium sulfate dihydrate included in a number of examples is a fine-grained calcium sulfate dihydrate, termed here as landplaster available from the United States Gypsum Company. The landplaster has an average particle size of about 15 microns.

Sand used in various examples was QUIKRETE Commercial Grade Fine Sand No. 1961. The particle size analysis of sand used is shown in TABLES H.

TABLE H
Typical Mean % Retained on Individual Sieves

| ASTM (Mesh #) | Microns |
|---|---|
| 30 Mesh | 100 |
| 40 Mesh | 98 |
| 50 Mesh | 69 |
| 70 Mesh | 23 |
| 100 Mesh | 5 |
| 140 Mesh | 1 |
| 200 Mesh | 0 |

TABLE I shows the chemical analysis of Class C fly ash (Campbell Power Plant, West Olive, Mich.), calcium sulfoaluminate cement (CTS FASTROCK 500) and calcium aluminate cement (Kerneos TERNAL EV) used in the examples.

TABLE I
Chemical Analysis-Mean % by Weight

| | | Calcium | Calcium |
|---|---|---|---|
| | Fly | Sulfoaluminate | Aluminate |
| Oxide | Ash | Cement | Cement |
| Silicon Dioxide (SiO₂) | 40.37 | 14.29 | 4.41 |
| Iron Oxide (Fe₂O₃) | 6.27 | 1.10 | 6.51 |
| Aluminum Oxide (Al₂O₃) | 19.38 | 26.21 | 36.72 |
| Calcium Oxide (CaO) | 23.19 | 45.45 | 48.44 |
| Magnesium Oxide (MgO) | 5.02 | 2.71 | 0.48 |
| Potassium Oxide (K₂O) | 0.69 | 0.41 | 0.17 |
| Sodium Oxide (Na₂O) | 1.08 | 0.45 | 0.15 |
| Sulfur Trioxide (SO₃) | 1.19 | 7.60 | 0.17 |
| Phosphorus Pentoxide (P₂O₅) | 1.08 | — | — |
| Titanium Dioxide (TiO₂) | 1.31 | 0.73 | 1.41 |
| Loss on Ignition (L.O.I.) | 0.42 | 1.05 | 1.54 |

PULVERIZED HIGH CALCIUM QUICKLIME available from Graymont is a high calcium quicklime. It is a fine white powder obtained by the calcination of high-purity limestone and composed essentially of calcium oxide (CaO). The chemical composition of PULVERIZED HIGH CALCIUM QUICKLIME is shown in TABLE J.

TABLE J
Chemical Analysis-Mean % by Weight

| | PULVERIZED |
|---|---|
| | HIGH CALCIUM |
| Oxide | QUICKLIME |
| Silicon Dioxide (SiO₂) | 1.4 |
| Iron Oxide (Fe₂O₃) | 0.2 |
| Aluminum Oxide (Al₂O₃) | 0.6 |
| Calcium Oxide (CaO) | 95.4 |
| Magnesium Oxide (MgO) | 1.0 |
| Total Sulfur (S) | 0.02 |
| Total Carbon (C) | 0.1 |
| Loss on Ignition (L.O.I.) | 1.1 |

The particle size of PULVERIZED HIGH CALCIUM QUICKLIME is shown in TABLE K below:

TABLE K
Particle Size (wt % passing)

| Sieve | PULVERIZED |
|---|---|
| Size | HIGH CALCIUM |
| (USA) | QUICKLIME |
| No 100 | 100 |
| No. 200 | 96 |
| No. 325 | 80 |

MAGCHEM 30 available from Martin Marietta Magnesia Specialties is a light burned magnesium oxide. It is a high purity, light burned magnesium oxide produced from magnesium-rich brine and dolomitic lime. This fine white powder has a high reactivity index and a low bulk density. The median particle size of MAGCHEM 30 is between 3 to 8 microns. The particle size of MAGCHEM 30 with % passing 325 mesh is 99% by weight.

The chemical composition of MAGCHEM 30 is shown in TABLE L below:

TABLE L
Chemical Analysis-Mean % by Weight

| Oxide | MAGCHEM 30 |
|---|---|
| Silicon Dioxide (SiO₂) | 0.35 |
| Iron Oxide (Fe₂O₃) | 0.15 |
| Aluminum Oxide (Al₂O₃) | 0.10 |
| Calcium Oxide (CaO) | 0.80 |
| Magnesium Oxide (MgO) | 98.2 |
| Chloride (Cl) | 0.35 |
| Sulfate (SO3) | 0.05 |
| Loss on Ignition (L.O.I.) | 1.7 |

DOLO QL PULVERIZED WITH FLO AID BULK available from Carameuse is a dolomitic quicklime. It is a fine white powder obtained by the calcination of dolomitic limestone and composed of calcium oxide (CaO) and magnesium oxide (MgO). The chemical composition of DOLO QL PULVERIZED WITH FLO AID BULK is shown in TABLE M. The particle size of DOLO QL PULVERIZED WITH FLO AID BULK with % passing 200 mesh is 97.7% by weight.

TABLE M
Chemical Analysis-Mean % by Weight

| | DOLO QL |
|---|---|
| | PULVERIZED |
| | WITH |
| Oxide | FLO AID BULK |
| Silicon Dioxide (SiO₂) | 1.33 |
| Iron Oxide (Fe₂O₃) | 0.22 |
| Aluminum Oxide (Al₂O₃) | 0.43 |
| Calcium Oxide (CaO) | 58.8 |
| Magnesium Oxide (MgO) | 38.3 |
| Total Sulfur (S) | 0.025 |
| Loss on Ignition (L.O.I.) | 1.07 |

PREVENT C, available from Premiere Magnesia, is a magnesium oxide based fine powder that is coated with an alkyl glycol coating. It contains about 90 to 95 wt % magnesium oxide, 5 to 10 wt % alkyl glycol coating, and less than 1.0 wt % silica (quartz).

CONEX, available from Euclid Chemical Company, is a calcium oxide based fine powder. It contains about 50 to 80 wt % calcium oxide, 20 to 40 wt % fused silica, 1 to 5 wt % aluminum oxide, 1 to 5 wt % crystalline silica, 5 to 10 wt % Portland cement, and less 1.0 wt % iron oxide.

COMPCON, available from ShrinkageComp Plus Inc., is a calcium oxide based fine powder.

In all of Examples 1-8, the materials of the mixtures investigated were mixed for 3 minutes in a Hobart mixer to prepare the slurry for testing fresh and physical properties. Two-inch cube specimens were cast for compressive strength testing. In all of Examples 1-8, the sand used was QUIKRETE Commercial Grade Fine Sand No. 1961.

### Example 1

TABLE 1.1 shows the raw material composition of the mixtures investigated in Example 1. Mix 1 was a comparative composition without any alkaline earth metal oxide in it. Mix 2 through 4 contained pulverized high calcium quicklime as the inorganic mineral comprising alkaline earth metal oxide.

TABLE 1.1
Compositions investigated in Example 1

| | Mix 1 | | | |
|---|---|---|---|---|
| Raw Material | Comparative | Mix 2 | Mix 3 | Mix 4 |
| Fly Ash Class | 3750.0 | 3902.4 | 3809.5 | 3720.9 |
| C (grams) | | | | |
| Quicklime (grams) | 0.0 | 97.6 | 190.5 | 279.1 |
| Total Cementitious | 3750.0 | 4000.0 | 4000.0 | 4000.0 |
| Materials (grams) | | | | |
| Sand (grams) | 3937.5 | 4200.0 | 4200.0 | 4200.0 |
| Sodium Citrate | 73.0 | 80.0 | 80.0 | 80.0 |
| Dihydrate (grams) | | | | |
| Superplasticizer | 18.8 | 20.0 | 20.0 | 20.0 |
| (grams) | | | | |
| Rheology Modifier | 7.5 | 4.0 | 4.0 | 4.0 |
| (grams) | | | | |
| Water (grams) | 1218.8 | 1300.0 | 1300.0 | 1300.0 |

Cementitious Materials are Fly Ash Class C and Calcium Oxide. Quicklime is PULVERIZED HIGH CALCIUM QUICKLIME from Graymont. Rheology modifier is AN BERMCOLL E 230X.

TABLE 1.2 shows the properties of the compositions investigated in this example.

TABLE 1.2
Properties of Compositions Investigated in Example 1

| | | Final Setting | 28-Day |
|---|---|---|---|
| | Slump | Time | Compressive |
| Mix # | (inches) | (minutes) | Strength (psi) |
| 1 | 9.0 | 79 | 4489 |
| 2 | 8.0 | 150 | 4843 |
| 3 | 9.0 | 172 | 6853 |
| 4 | 7.5 | 158 | 5107 |

From the results shown in Table 1.2, the following observations can be made:
All mixes had good rheology and flow properties as indicated by the slump data in the Table 1.2. Mix 4 with highest amount of high calcium quicklime resulted in only a slight decrease in slump.
The comparative mix (Mix 1) with no high calcium quicklime had the shortest setting time. Mixes containing high calcium quicklime demonstrated an increase in the final set time. The final set almost doubled even at a low addition rates of quicklime in the composition. This property can be beneficially harnessed in tailoring the setting behavior of the geopolymer mixture compositions of this invention for specific applications.
The compressive strength of the mixture compositions increased substantially with incorporation of high calcium quicklime in the compositions. The 28-day compressive strength was highest at a high calcium quicklime addition rate of 5 pbw of fly ash (Mix 2). It is noteworthy that the compressive strength of Mix 2 was 6853 psi, which represents almost an forty two percent increase in compressive strength compared to that for the comparative mixture (Mix 1) having a compressive strength of only 4489 psi. This is an unexpected result, which can be very usefully harnessed for tailoring the compressive strength of the geopolymer compositions of this invention in various applications.

### Example 2

TABLE 2.1 shows the raw material composition of the mixtures investigated in Example 2. All three mixes contained pulverized high calcium quicklime as the inorganic mineral comprising alkaline earth metal oxide. In addition to compressive strength testing the cast cube specimens were also tested for dimensional movement characteristics when exposed to a drying in a controlled environment of 75° F. and 50% relative humidity. In the results below, material shrinkage is expressed as a negative number and material expansion is expressed as a positive number.

TABLE 2.1
Compositions investigated in Example 2

| Raw Material | Mix 1 | Mix 2 | Mix 3 |
|---|---|---|---|
| Fly Ash Class C (grams) | 3478.3 | 3333.3 | 3200.0 |
| Quicklime (grams) | 521.7 | 666.7 | 800.0 |
| Total Cementitious Materials (grams) | 4000.0 | 4000.0 | 4000.0 |
| Sand (grams) | 4200.0 | 4200.0 | 4200.0 |
| Sodium Citrate Dihydrate (grams) | 80.0 | 80.0 | 80.0 |
| Superplasticizer (grams) | 20.0 | 20.0 | 20.0 |
| Rheology Modifier (grams) | 4.0 | 4.0 | 4.0 |
| Water (grams) | 1300.0 | 1300.0 | 1300.0 |

Cementitious Materials are Fly Ash Class C and Quicklime.
PULVERIZED HIGH CALCIUM QUICKLIME from Graymont.
Rheology modifier is AN BERMCOLL E 230X.

TABLE 2.2 shows the properties of the compositions investigated in this example.

TABLE 2.2
Properties of Compositions Investigated in Example 2

| | | Final Setting | 28-Day | 64-Day |
|---|---|---|---|---|
| | Slump | Time | Compressive | Drying |
| Mix # | (inches) | (minutes) | Strength (psi) | Shrinkage (%) |
| 1 | 7.0 | 94 | 4072 | −0.37 |
| 2 | 6.5 | 74 | 4238 | −0.07 |
| 3 | 4.75 | 51 | 3790 | +0.79 |

From the results shown in Table 2.2, the following observations can be made:
All mixes exhibited satisfactory rheology and flow properties as indicated by the slump data in the table. The flow (slump) of the slurry mixtures reduced with increase in the amount of high calcium quicklime in the composition. Thus, it can be concluded that high calcium quicklime used in this example acted as a thickening agent in the geopolymer compositions of this invention. This property can be beneficially harnessed for tailoring rheology of the geopolymer mixture compositions of this invention for specific applications.
At the higher dosage rates of high calcium quicklime investigated in this example, it can be observed that the final set time decreased with increase in the amount of quicklime in the composition. This result is unexpected and contrary to what was observed in Example 1. It can be concluded that the lower addition rates of high calcium quicklime in the geopolymer compositions of this invention prolong the final set time as observed in Example 1. On the other hand, the higher addition rates of high calcium quicklime have the opposite effect of shortening the final set time as observed in the present Example. This property can be beneficially harnessed for tailoring the setting behavior of the geopolymer mixture compositions of this invention for specific applications.
At the higher dosage rates of high calcium quicklime investigated in this example, it can be observed that the 28-day compressive strength remained practically unchanged. However, compared to Mix 2 of Example 1 comprising 5 pbw of quicklime, the compositions of this example had substantially lower compressive strength. Thus, it can be concluded that when job specifications call for higher compressive strength performance, higher dosage of high calcium quicklime are not advisable in the geopolymer composition of this invention.
The drying shrinkage of the material decreased with increase in the amount of quicklime in the composition. It can be noted that the material shrinkage was only −0.07% for Mix 2. Moreover, it is noteworthy that, the material exhibited a significant expansion for Mix 3 with a resultant expansion of +0.78%. This feature is particularly useful when the material is used for grouting and anchoring applications with external or internal confinement to facilitate development of residual compressive stresses in the material.

### Example 3

TABLE 3.1 shows the raw material composition of the composition investigated in Example 3. A lightly burned magnesium oxide was used as the inorganic mineral comprising alkaline earth metal oxide in this example.

TABLE 3.1
Composition investigated in Example 3

| Raw Material | Mix 1 |
|---|---|
| Fly Ash Class C (grams) | 3200.0 |
| Magnesium Oxide (grams) | 800.0 |
| Total Cementitious Materials (grams) | 4000.0 |
| Sand (grams) | 4200.0 |
| Sodium Citrate Dihydrate (grams) | 80.0 |
| Superplasticizer (grams) | 20.0 |
| Rheology Modifier (grams) | 4.0 |
| Water (grams) | 1300.0 |

Cementitious Materials are Fly Ash Class C and Magnesium Oxide.
Magnesium Oxide is MAGCHEM 30, a light burned magnesium oxide from Martin Marietta Magnesia Specialties.
Rheology modifier is AN BERMCOLL E 230X.

TABLE 3.2 shows the properties of the composition investigated in this example.

TABLE 3.2
Properties of Composition Investigated in Example 3

| | | Final Setting | 28-Day |
|---|---|---|---|
| | Slump | Time | Compressive |
| Mix # | (inches) | (minutes) | Strength (psi) |
| 1 | 5.5 | 44 | 4644 |

From the results shown in TABLE 3.2, the following observations can be made:
The mix investigated in this example had satisfactory rheology and flow properties as indicated by the slump data in the table.
The final setting time of the mix investigated in this example was shorter than the equivalent mix investigated in the previous example containing high calcium quicklime (Mix 3 of Example 2). Thus, it can be concluded that light burned magnesium oxide results in a shorter final setting time than that obtained with high calcium quicklime added at a similar dosage rate.
The compressive strength of the mix comprising light burned magnesium oxide, at the dosage rate investigated, is greater than 4500 psi at 28-days. This represents a satisfactory strength for most residential, commercial, and industrial applications.

### Example 4

TABLE 4.1 shows the raw material composition of the mixtures investigated in Example 4. All mixes contained a quicklime based mineral admixture as part of the composition. The sand used in this example is QUIKRETE Commercial Grade Fine Sand No. 1961. In addition to compressive strength testing the cast cube specimens were also tested for dimensional movement characteristics when exposed to drying in a controlled environment of 75° F. and 50% relative humidity. In the results below, material shrinkage is expressed as a negative number and material expansion is expressed as a positive number.

TABLE 4.1
Compositions investigated in Example 4

| Raw Material | Mix 1 | Mix 2 | Mix 3 | Mix 4 |
|---|---|---|---|---|
| Fly Ash Class C (grams) | 3636.4 | 3478.3 | 3333.3 | 3200.0 |
| Quicklime Based Mineral | 363.6 | 521.7 | 666.7 | 800.0 |
| Admixture (grams) | | | | |
| Total Cementitious Materials | 4000.0 | 4000.0 | 4000.0 | 4000.0 |
| (grams) | | | | |
| Sand (grams) | 4200.0 | 4200.0 | 4200.0 | 4200.0 |
| Sodium Citrate Dihydrate (grams) | 80.0 | 80.0 | 80.0 | 80.0 |
| Superplasticizer (grams) | 20.0 | 20.0 | 20.0 | 20.0 |
| Rheology Modifier (grams) | 4.0 | 4.0 | 4.0 | 4.0 |
| Water (grams) | 1300.0 | 1300.0 | 1300.0 | 1300.0 |

Cementitious Materials are Fly Ash Class C and Quicklime Based Mineral Admixture.
Quicklime Based Mineral Admixture is a commercial product available with trade name CompCon.
Rheology modifier is AN BERMCOLL E 230X.

TABLE 4.2 shows the properties of the compositions investigated in this example.

TABLE 4.2
Properties of Compositions Investigated in Example 4

| | | Final Setting | 28-Day | 58-Day Drying |
|---|---|---|---|---|
| | Slump | Time | Compressive | Shrinkage/ |
| Mix # | (inches) | (minutes) | Strength (psi) | Expansion (%) |
| 1 | 7.25 | 122 | 4799 | −0.60 |
| 2 | 7.00 | 145 | 4605 | −0.39 |
| 3 | 6.75 | 132 | 4417 | −0.23 |
| 4 | 5.75 | 129 | 3978 | −0.02 |

From the results shown in TABLE 4.2, the following observations can be made:
The flow (slump) of the slurry mixtures reduced slightly with increase in the amount of quicklime based mineral admixture in the composition. Thus, it can be concluded that quicklime based mineral admixture used in this example acted as a thickening agent in the geopolymer compositions of this invention. This property can be beneficially harnessed in tailoring the rheology of the geopolymer mixture compositions of this invention for specific applications.
At the dosage rates of quicklime based mineral admixture investigated in this example, the final set times of all mixes were in the range of 2 to 2½ hours.
The compressive strength of the mixes decreased with increase in the amount of quicklime based mineral admixture in the compositions. The 28-day compressive strength was highest (4799 psi) for Mix 1, which had a quicklime based mineral admixture addition rate of 10 pbw of fly ash. On the other hand, the 28-day compressive strength was lowest (3978 psi) for Mix 4, which had a quicklime based mineral admixture addition rate of 25 pbw of fly ash.
The drying shrinkage reduced with increase in the amount of quicklime in the composition. The drying shrinkage for Mix 1 was −0.60% at the age of 58 days, while the same for Mix 4 was only −0.02%. This represented a significant reduction in shrinkage due to the incorporation of increased amount of quicklime based mineral admixture in the compositions of this invention.

### Example 5

TABLE 5.1 shows the raw material composition of the mixtures investigated in Example 5. All mixes contained pulverized high calcium quicklime as the inorganic mineral comprising alkaline earth metal oxide. All mixes also contained calcium sulfoaluminate cement and land plaster (gypsum). In addition to compressive strength testing the cast cube specimens were also tested for dimensional movement characteristics when exposed to a drying in a controlled environment of 75° F. and 50% relative humidity. In the results below, material shrinkage is expressed as a negative number and material expansion is expressed as a positive number.

TABLE 5.1
Compositions investigated in Example 5

| | Mix 1 | | | |
|---|---|---|---|---|
| | Compar- | | | |
| Raw Material | ative | Mix 2 | Mix 3 | Mix 4 |
| Fly Ash Class C (grams) | 2631.6 | 2507.6 | 2395.2 | 2292.3 |
| Calcium Sulfoaluminate | 1052.6 | 1003.1 | 958.1 | 916.9 |
| Cement (grams) | | | | |
| Landplaster (grams) | 315.8 | 300.9 | 287.4 | 275.1 |
| Quicklime (grams) | 0.0 | 188.1 | 359.3 | 515.8 |
| Total Cementitious | 4000.0 | 4000.0 | 4000.0 | 4000.0 |
| Materials (grams) | | | | |
| Sand (grams) | 4200.0 | 4200.0 | 4200.0 | 4200.0 |
| Sodium Citrate Dihydrate | 80.0 | 80.0 | 80.0 | 80.0 |
| (grams) | | | | |
| Superplasticizer (grams) | 20.0 | 20.0 | 20.0 | 20.0 |
| Rheology Modifier (grams) | 4.0 | 4.0 | 4.0 | 4.0 |
| Water (grams) | 1300.0 | 1300.0 | 1300.0 | 1300.0 |

Cementitious Materials are Fly Ash Class C and Quicklime.
Quicklime is PULVERIZED HIGH CALCIUM QUICKLIME from Graymont.
Rheology modifier is AN Bermocoll E 230X.

TABLE 5.2 shows the properties of the compositions investigated in this example.

TABLE 5.2
Properties of Compositions Investigated in Example 5

| | | Final Setting | 28-Day | 57-Day Drying |
|---|---|---|---|---|
| | Slump | Time | Compressive | Shrinkage/ |
| Mix # | (inches) | (minutes) | Strength (psi) | Expansion (%) |
| 1 | 9.00 | 129 | 3615 | −0.11 |
| 2 | 3.75 | 123 | 5231 | −0.22 |
| 3 | 3.50 | 136 | 5215 | +0.25 |
| 4 | 2.00 | 119 | 6644 | +0.57 |

From the results shown in TABLE 5.2, the following observations can be made:
The flow (slump) of the slurry mixtures reduced with increase in the amount of high calcium quicklime in the composition. Thus, it can be concluded that high calcium quicklime acted as a thickening agent in the geopolymer compositions of this invention. This is an unexpected result. This property can be beneficially harnessed in tailoring the rheology of the geopolymer mixture compositions of this invention for specific applications.
The compressive strength of the mixture compositions investigated in this example increased substantially with an increase in the amount of high calcium quicklime in the composition. It is noteworthy that the compressive strength of Mix 4 was 6644 psi, which represents almost an eighty four percent increase in compressive strength compared to that for the comparative mixture (Mix 1) having a compressive strength of only 3615 psi. This is an unexpected result, which can be very usefully harnessed for tailoring the compressive strength of the geopolymer compositions of this invention in various applications.
The drying shrinkage of the mixture compositions decreased with an increase in the amount of high calcium quicklime in the composition. Mix 1 with no quicklime had an ultimate shrinkage of about −0.10% at an age of 55 days. On the other hand, it is noteworthy that the mixture compositions comprising higher amounts of high calcium quicklime exhibited a resultant expansion. Mix 3 had a resultant expansion of +0.25% and Mix 4 had a resultant expansion of +0.57%. This feature is particularly useful when the material is used for grouting and anchoring applications with external or internal confinement to develop residual compressive stresses in the material.

### Example 6

TABLE 6.1 shows the raw material composition of the mixtures investigated in Example 6. Three mixes (Mixes 1, 2 and 3) contained pulverized dolomitic quicklime as the inorganic mineral comprising alkaline earth metal oxide. The fourth mix (Mix 4) was a comparative mix. All mixes also contained calcium sulfoaluminate cement and land plaster (gypsum).

TABLE 6.1
Compositions investigated in Example 6

| | | | | Mix 4 |
|---|---|---|---|---|
| | | | | Compar- |
| Raw Material | Mix 1 | Mix 2 | Mix 3 | ative |
| Fly Ash Class C (grams) | 2836.9 | 3370.8 | 3319.5 | 3539.8 |
| Calcium Sulfoaluminate | 567.4 | 674.2 | 332.0 | 354.0 |
| Cement (grams) | | | | |
| Landplaster (grams) | 170.2 | 202.2 | 99.6 | 106.2 |
| Dolomitic Quicklime (grams) | 425.5 | 252.8 | 249.0 | 0.0 |
| Total Cementitious Materials | 4000.0 | 4500.0 | 4000.0 | 4000.0 |
| (grams) | | | | |
| Sand (grams) | 4200.0 | 4725.0 | 4200.0 | 4200.0 |
| Sodium Citrate Dihydrate | 80.0 | 90.0 | 120.0 | 120.0 |
| (grams) | | | | |
| Superplasticizer (grams) | 20.0 | 22.5 | 20.0 | 20.0 |
| Water (grams) | 960.0 | 1080.0 | 960.0 | 960.0 |

Cementitious Materials are Fly Ash Class C and Dolomitic Quicklime.
Dolomitic Quicklime is DOLO QL Pulverized With FLO AID BULK from Carmeuse.

TABLE 6.2 shows the properties of the compositions investigated in this example.

TABLE 6.2
Properties of Compositions Investigated in Example 6

| | | Final Setting | 28-Day |
|---|---|---|---|
| | Slump | Time | Compressive |
| Mix # | (inches) | (minutes) | Strength (psi) |
| 1 | 2.00 | 134 | 7672 |
| 2 | 3.00 | 69 | 8559 |
| 3 | 3.25 | 87 | 8226 |
| 4 | 10.50 | 37 | 7289 |

From the results shown in TABLE 6.2, the following observations can be made:
The flow of the slurry mixtures reduced with increase in the amount of dolomitic quicklime in the composition. It can be noted that the comparative mix (Mix 4) with no dolomitic quicklime had a slump of 10.5 inches. On the other hand, addition of dolomitic quicklime the compositions of this invention reduced the slump to 2 to 3¼ inches. Thus, it can be concluded that dolomitic quicklime acted as a thickening agent in the geopolymer compositions of this invention. This is an unexpected result. This property can be beneficially harnessed in tailoring the rheology of the geopolymer mixture compositions of this invention for specific applications.
The final set times of the mixes investigated in this example increased with an increase in the amount of dolomitic quicklime in the composition. It can be noted that the comparative mix (Mix 4) with no dolomitic quicklime had a final set time of 37 minutes. On the other hand, addition of dolomitic quicklime in Mix 3 increased the final set time of the composition to 87 minutes. Moreover, Mix 1 comprising the highest amount of dolomitic quicklime investigated in this example had the longest final set time equal to 154 minutes. Thus, it can be concluded that dolomitic quicklime acted as a set retarder in the geopolymer compositions of this invention. Again, this property can be beneficially harnessed in tailoring the setting behavior of the geopolymer mixture compositions of this invention for specific applications.
The compressive strength of the mixture compositions investigated in this example increased with incorporation of dolomitic quicklime in the composition. It is noteworthy that compressive strength greater than 8000 psi are achievable for geopolymer compositions of this invention incorporating inorganic mineral comprising alkaline earth metal oxide minerals. This feature can be usefully harnessed to tailor compressive strength of the geopolymer compositions of this invention in various applications.

### Example 7

TABLE 7.1 shows the raw material composition of the mixtures investigated in Example 7. The first mix (Mix 1) was a comparative mixture composition. The remaining four mixes (Mixes 2 through 5) contained a magnesium oxide based mineral admixture. All mixes also contained calcium sulfoaluminate cement and gypsum. In addition to compressive strength testing the cast cube specimens were also tested for dimensional movement characteristics when exposed to a drying in a controlled environment of 75° F. and 50% relative humidity. In the results below, material shrinkage is expressed as a negative number and material expansion is expressed as a positive number.

TABLE 7.1
Compositions investigated in Example 7

| | Mix 1 | | | | |
|---|---|---|---|---|---|
| | Compar- | | | | |
| Raw Material | ative | Mix 2 | Mix 3 | Mix 4 | Mix 5 |
| Fly Ash Class C | 4423.1 | 4339.6 | 4259.3 | 4181.8 | 4107.1 |
| (grams) | | | | | |
| Calcium Sulfoalumin- | 884.6 | 867.9 | 851.9 | 836.4 | 821.4 |
| ate Cement (grams) | | | | | |
| Gypsum (grams) | 442.3 | 434.0 | 425.9 | 418.2 | 410.7 |
| Magnesium Oxide | 0.0 | 108.5 | 213.0 | 313.6 | 410.7 |
| Based Mineral | | | | | |
| Admixture (grams) | | | | | |
| Total Cementitious | 5750.0 | 5750.0 | 5750.0 | 5750.0 | 5750.0 |
| Materials (grams) | | | | | |
| Sand (grams) | 6612.5 | 6612.5 | 6612.5 | 6612.5 | 6612.5 |
| Potassium Citrate | 115.0 | 115.0 | 115.0 | 115.0 | 115.0 |
| Monohydrate (grams) | | | | | |
| Superplasticizer | 28.8 | 28.8 | 28.8 | 28.8 | 28.8 |
| (grams) | | | | | |
| Citric Acid (grams) | 28.8 | 28.8 | 28.8 | 28.8 | 28.8 |
| Sodium Gluconate | 7.2 | 7.2 | 7.2 | 7.2 | 7.2 |
| (grams) | | | | | |
| Axilat RH100 XP | 0.35 | 0.35 | 0.35 | 0.35 | 0.35 |
| Elementis BENTONE | 0.58 | 0.58 | 0.58 | 0.58 | 0.58 |
| CT | | | | | |
| Yipin BLACK S350M | 4.3 | 4.3 | 4.3 | 4.3 | 4.3 |
| SURFYNOL 500S | 11.5 | 11.5 | 11.5 | 11.5 | 11.5 |
| Water (grams) | 1581.3 | 1581.3 | 1581.3 | 1581.3 | 1581.3 |

Cementitious Materials are Fly Ash Class C, Calcium Sulfoaluminate Cement, Gypsum, and Magnesium Oxide Based Mineral Admixture.
Gypsum used was USG Terra Alba from USG Corporation.
Magnesium Oxide Based Mineral Admixture is PREVent-C from Premier Magnesia.

TABLE 7.2 shows the properties of the compositions investigated in this example.

TABLE 7.2
Properties of Compositions Investigated in Example 7

| | | Final | 4-Hour | 28-Day | 54-Day |
|---|---|---|---|---|---|
| | | Setting | Compressive | Compressive | Drying |
| | Slump | Time | Strength | Strength | Shrinkage/ |
| Mix # | (inches) | (minutes) | (psi) | (psi) | Expansion (%) |
| 1 | 9.50 | 72 | 1661 | 5154 | −0.05 |
| 2 | 9.75 | 66 | 1532 | 4602 | −0.04 |
| 3 | 10.25 | 76 | 1417 | 4434 | −0.03 |
| 4 | 10.00 | 90 | 1203 | 4209 | −0.02 |
| 5 | 9.25 | 118 | 1034 | 3617 | −0.02 |

From the results shown in TABLE 7.2, the following observations can be made:
The flow of the slurry mixtures remained practically unaffected with the addition of the investigated magnesium oxide based mineral admixture in the composition. This is a desirable feature in applications where it is important to have a good flow and working properties for the slurry mixture in its fresh state.
The final set times of the mixes investigated in this example increased with an increase in the amount of magnesium oxide based mineral admixture in the composition. It should be noted that the comparative mix (Mix1) with no magnesium oxide based mineral admixture had a final set time of 72 minutes. On the other hand, addition of magnesium oxide based mineral admixture in Mix 5 increased the final set time of the composition to 118 minutes. Thus, it can be concluded that magnesium oxide based mineral admixture acted as a set retarder in the geopolymer compositions of this invention. This property can be beneficially harnessed for tailoring the setting behavior of the geopolymer mixture compositions of this invention for specific applications.
The compressive strength of the mixture compositions investigated in this example decreased with increasing amounts of magnesium based mineral admixture in the composition.
The shrinkage of the mixture compositions investigated in this example decreased slightly with an increase in the magnesium based mineral admixture in the composition. For instance, the comparative mix (Mix
1) with no magnesium based mineral admixture had shrinkage of −0.05%. On the other hand, the shrinkage for Mix 5 containing magnesium oxide mineral admixture reduced to −0.02%.

### Example 8

TABLE 8.1 shows the raw material composition of the mixtures investigated in Example 8. The first mix (Mix 1) was a comparative mixture composition. The second mix (Mix 2) contained a calcium oxide based mineral admixture. Both mixes also contained calcium sulfoaluminate cement and gypsum.

TABLE 8.1
Compositions investigated in Example 8

| | Mix 1 | |
|---|---|---|
| Raw Material | Comparative | Mix 2 |
| Fly Ash Class C (grams) | 4423.1 | 4259.3 |
| Calcium Sulfoaluminate Cement | 884.6 | 851.9 |
| (grams) | | |
| Gypsum (grams) | 442.3 | 425.9 |
| Calcium Oxide Based Mineral | 0.0 | 213.0 |
| Admixture (grams) | | |
| Total Cementitious Materials (grams) | 5750.0 | 5750.0 |
| Sand (grams) | 6612.5 | 6612.5 |
| Potassium Citrate Tribasic | 115.0 | 115.0 |
| Monohydrate (grams) | | |
| Superplasticizer (grams) | 28.8 | 28.8 |
| Citric Acid (grams) | 28.8 | 28.8 |
| Sodium Gluconate (grams) | 7.2 | 7.2 |
| AXILAT RH100 XP (grams) | 0.35 | 0.35 |
| Elementis BENTONE CT (grams) | 0.58 | 0.58 |
| Yipin BLACK S350M (grams) | 4.3 | 4.3 |
| SURFYNOL 500S (grams) | 11.5 | 11.5 |
| Water (grams) | 1581.3 | 1581.3 |

Cementitious Materials are Fly Ash Class C, Calcium Sulfoaluminate Cement, Gypsum, and Calcium Oxide Based Mineral Admixture.
Gypsum used was USG TERRA ALBA from USG Corporation.
Calcium Oxide Based Mineral Admixture is CONEX from Euclid Chemicals.

TABLE 8.2 shows the properties of the compositions investigated in this example.

TABLE 8.2
Properties of Compositions Investigated in Example 8

| | | Final Setting | 4-Hour | 28-Day |
|---|---|---|---|---|
| | Slump | Time | Compressive | Compressive |
| Mix # | (inches) | (minutes) | Strength (psi) | Strength (psi) |
| 1 | 9.50 | 72 | 1661 | 5154 |
| 2 | 5.00″ | >270 | 54 | 9243 |

From the results shown in TABLE 8.2, the following observations can be made:
The flow of the slurry mixtures decreased with the addition of the investigated calcium oxide based mineral admixture in the composition. This is an unexpected result. This attribute is useful and can be practically harnessed to tailor the material rheology of the geopolymer compositions of this invention for intended applications.
The final set times of the mixes investigated in this example increased substantially with the addition of calcium oxide based mineral admixture in the composition. It should be noted that the comparative mix (Mix1) with no calcium oxide based mineral admixture had a final set time of 72 minutes. On the other hand, addition of calcium oxide based mineral admixture in Mix 2 increased the final set time of the composition to greater than 270 minutes. Thus, it can be concluded that calcium oxide based mineral admixture investigated in this example acted as a set retarder in the geopolymer compositions of this invention. This is an unexpected result, which can be very usefully harnessed to tailor setting behavior of the geopolymer compositions of this invention in various applications.
The compressive strength of the mixture composition comprising calcium based mineral admixture investigated in this example increased significantly compared to the comparative mixture without calcium oxide based mineral admixture. It is noteworthy that the compressive strength of Mix 2 was 9243 psi, which represents almost an eighty percent increase in compressive strength compared to that for the comparative mixture having a compressive strength of 5154 psi. This is an unexpected result, which can be very usefully harnessed for tailoring compressive strength of the geopolymer compositions of this invention in various applications.

### CLAUSES OF THE INVENTION

The following clauses describe various aspects of the present invention:

Clause 1. A geopolymer composition comprising a mixture of:

cementitious reactive powder comprising:
thermally activated aluminosilicate mineral in an amount of 100 parts by weight, wherein preferably the thermally activated aluminosilicate mineral comprises at least 75% Class C fly ash, and
inorganic mineral comprising alkaline earth metal oxide, wherein the inorganic mineral comprising alkaline earth metal oxide is in an amount of 0.50 to 40, preferably 1 to 30, more preferably 2 to 20 pbw per said 100 parts by weight of thermally activated aluminosilicate mineral,
optionally at least one aluminate cement, and
optionally at least one calcium sulfate; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the composition has an air content of about 3% to 20% by volume, more preferably about 4% to 12% by volume, and most preferably about 4% to 8% by volume,

wherein said thermally activated aluminosilicate mineral, said optional aluminate cement, said optional calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder.

Clause 2. The composition of clause 1, wherein the cementitious reactive powder further comprises:
the aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement, and
the calcium sulfate in an amount of 2 to 100, preferably 5 to 75, more preferably 10 to 50 parts by weight per 100 pbw of aluminate cement, wherein the calcium sulfate is selected from at least one member of the group consisting of calcium sulfate dihydrate, calcium sulfate hemihydrate, and anhydrous calcium sulfate.

Clause 3. The composition of clause 1 or 2, wherein the inorganic mineral comprising alkaline earth metal oxide comprises calcium oxide, or magnesium oxide or a combination of calcium oxide and magnesium oxide;

wherein the thermally activated aluminosilicate mineral comprises at least 75% Class C fly ash.

Clause 4. The composition of clause 1, 2 or 3,

wherein the composition is made from setting a slurry comprising water, the cementitious reactive powder, the alkali metal chemical activator, and the freeze-thaw durability component, wherein the water/cementitious reactive powder weight ratio of the slurry is 0.14 to 0.55:1,

wherein the composition contains at least one of the feature selected from the group consisting of:
air-entraining agent in an amount of 0.01 to 1 weight % based upon the total weight of the cementitious reactive powder, and
surface active organic polymer in an amount of 1 to 20 weight % based upon the total weight of the cementitious reactive powder,

wherein the composition after setting has a relative dynamic modulus greater than 80% for at least 100 freeze-thaw cycles according to ASTM C666/C666M-15, and

wherein the composition after setting has a weight loss less than 1% after 25 freeze-thaw cycles according to this ASTM C672/C672M-12 salt scaling test,

wherein the composition has a Durability Factor (DF) measured according to ASTM C666/C666M—15 greater than 85% for 100 freeze-thaw cycles.

Clause 5. The composition of clause 2, wherein the calcium sulfoaluminate cement is provided in the absence of calcium aluminate cement and an absence of Portland cement.

Clause 6. The composition of clause 2, wherein the calcium aluminate cement is provided in the absence of calcium sulfoaluminate cement and an absence of Portland cement.

Clause 7. The composition of clause 2, comprising 5 to 60 parts aluminate cement by weight per 100 pbw of thermally activated aluminosilicate mineral, the aluminate cement comprising the calcium sulfoaluminate cement and the calcium aluminate cement, wherein the amount of calcium aluminate cement is about 5 to about 75 parts by weight (pbw) per 100 pbw of total calcium sulfoaluminate cement and calcium aluminate cement, wherein the composition has an absence of Portland cement.

Clause 8. The composition of clause 1, 2 or 3, comprising the air entraining agent and the surface active organic polymer,

wherein the surface active organic polymer comprises at least one member of the group consisting of biopolymers, organic rheology control agents, film forming redispersible polymers, and film forming polymer of film forming polymer dispersions,

wherein the biopolymer is selected from at least one member of the group consisting of Succinoglycans, diutan gum, guar gum, wellan gum, xanthan gums galactomannan gums, glucomannan gums, guar gum, locust bean gum, cara gum, hydroxyethyl guar, hydroxypropyl guar, cellulose, hydroxypropyl cellulose, hydroxymethyl cellulose, and hydroxyethyl cellulose,

wherein the at least one organic rheology control agent comprises at least one acrylic-based polymer selected from the group consisting of alkali-swellable (or soluble) emulsions (ASE's), hydrophobically modified alkali-swellable emulsions (HASE's), and hydrophobically modified, ethoxylated urethane resins (HEUR's),

wherein the film forming redispersible polymer is selected from the group consisting of (meth)acrylic polymers, styrene polymers, styrene-butadiene rubber polymers, vinyl polymers, polyesters, polyurethanes, polyamides, chlorinated polyolefins, and mixtures or copolymers thereof, wherein said film forming polymer has a glass transition temperature (Tg) of from −40° to 70° C., and

wherein the film forming polymer of the film forming polymer dispersions is selected from the group consisting of (meth)acrylic polymers, styrene polymers, styrene-butadiene rubber polymers, vinyl polymers, polyesters, polyurethanes, polyamides, chlorinated polyolefins, and mixtures or copolymers thereof, wherein said film forming polymer has a glass transition temperature (Tg) of from −40° to 70° C.

Clause 9. The composition of clause 1, 2 or 3, wherein the composition has a freeze-thaw durability performance according to ASTM C666/C 666M-15 of a relative dynamic modulus of greater than 80 percent for at least 100 freeze-thaw cycles, typically at least 300 freeze-thaw cycles, preferably at least 600 freeze-thaw cycles, more preferably at least 900 freeze-thaw cycles, most preferably at least 1200 freeze-thaw cycles.

Clause 10. The composition of clause 1 or 3,

wherein the aluminate cement and calcium sulfate are absent;

wherein the cementitious reactive powder has:
100 pbw thermally activated aluminosilicate mineral and 0.50-40 pbw inorganic mineral comprising alkaline earth metal oxide,
preferably has 100 pbw thermally activated aluminosilicate mineral and 1-30 pbw inorganic mineral comprising alkaline earth metal oxide, and
more preferably has 100 pbw thermally activated aluminosilicate mineral and 2-20 pbw inorganic mineral comprising alkaline earth metal oxide.

Clause 11. The composition of clause 1, 2 or 3, comprising,

0 to 5 parts by weight fine aggregate per 1 part total weight of the cementitious reactive powder;

0 to 5.5 parts by weight coarse aggregate per 1 part total weight of the cementitious reactive powder;

25 to 40 parts said aluminate cement by weight per 100 pbw of thermally activated aluminosilicate mineral, the aluminate cement comprising the calcium sulfoaluminate cement and the calcium aluminate cement, wherein the amount of the calcium aluminate cement is about 30-45 parts by weight (pbw) per 100 pbw of total calcium sulfoaluminate cement and calcium aluminate cement, wherein the composition has an absence of Portland cement;

the air entraining agent,

the defoamer,

the superplasticizer comprising polycarboxylate polyether;

the surface active polymer comprising redispersible film forming polymer;

greater than 0 to at most 5 parts by weight fine aggregate per 1 part total weight of the cementitious reactive powder;

0 to 5.5 parts by weight coarse aggregate per 1 part total weight of the cementitious reactive powder;

the alkali metal salt chemical activator comprises potassium citrate;

air content of about 4% to 12% by volume;

wherein the thermally activated aluminosilicate mineral comprises at least 75% Class C fly ash.

Clause 12. The composition of clause 1, 2 or 3,

wherein the aluminate cement and calcium sulfate are present; and

wherein the cementitious reactive powder:
has 100 pbw thermally activated aluminosilicate mineral, 1-100 pbw aluminate cement, 2-100 pbw calcium sulfate, and 0.50-40 pbw inorganic mineral comprising alkaline earth metal oxide,
preferably has 100 pbw thermally activated aluminosilicate mineral, 2.5-80 pbw aluminate cement, 5-75 pbw calcium sulfate, and 1-30 pbw inorganic mineral comprising alkaline earth metal oxide, and
   more preferably has 100 pbw thermally activated aluminosilicate mineral, 5-60 pbw aluminate cement, 10-50 pbw calcium sulfate, and 2-20 pbw inorganic mineral comprising alkaline earth metal oxide.

Clause 13. A method for making geopolymer compositions of any of clauses 1-12, comprising the steps of:

preparing a slurry by mixing

water;

cementitious reactive powder comprising:
thermally activated aluminosilicate mineral in an amount of 100 parts by weight, wherein preferably the thermally activated aluminosilicate mineral comprises at least 75% Class C fly ash, and
inorganic mineral comprising alkaline earth metal oxide, wherein the inorganic mineral comprising alkaline earth metal oxide is in an amount of 0.50 to 40, preferably 1 to 30, more preferably 2 to 20 pbw per 100 parts by weight of thermally activated aluminosilicate mineral,
optionally at least one aluminate cement, and
optionally at least one calcium sulfate; and

alkali metal chemical activator in an amount of 1 to 6, preferably 1.25 to 4, more preferably 1.5 to 2.5 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;

freeze-thaw durability component in an amount of 0.05 to 21.5, preferably 0.1 to 10, more preferably 0.1 to 5 weight % based upon the total weight of the cementitious reactive powder, the freeze-thaw durability component comprising:
air-entraining agent in an amount of 0 to 1, preferably 0.01-0.5, more preferably 0.01-0.2, most preferably 0.05-0.2 weight % based upon the total weight of the cementitious reactive powder,
defoaming agent in an amount of 0 to 0.5, preferably 0-0.25, more preferably 0.01-0.1 weight % based upon the total weight of the cementitious reactive powder, and
surface active organic polymer in an amount of 0 to 20, preferably 0-10, more preferably 0-5 weight % based upon the total weight of the cementitious reactive powder;

wherein at least one member of the group consisting of the air-entraining agent and the surface active organic polymer is present,

wherein the slurry has an air content of about 3% to 20% by volume, more preferably about 4% to 12% by volume, and most preferably about 4% to 8% by volume,

wherein said thermally activated aluminosilicate mineral, said optional aluminate cement, said optional calcium sulfate, and said inorganic mineral comprising alkaline earth metal oxide is at least 70 wt. %, preferably at least 80 wt. %, more preferably at least 95 wt. %, most preferably 100 wt. % of the cementitious reactive powder;

wherein the water/cementitious reactive powder weight ratio of the slurry is 0.14 to 0.55:1, for example 0.14 to 0.45:1, preferably 0.16 to 0.50:1, for example 0.16 to 0.35:1, and more preferably 0.18 to 0.45:1, for example 0.18 to 0.25:1,

setting the slurry to form a set composition.

Clause 14. The method of clause 13, wherein the cementitious reactive powder further comprises:
the aluminate cement in an amount of 1 to 100, preferably 2.5-80, more preferably 5 to 60, most preferably 25 to 40 parts by weight (pbw) per 100 pbw of thermally activated aluminosilicate mineral, wherein preferably the aluminate cement is selected from at least one member of the group consisting of calcium sulfoaluminate cement and calcium aluminate cement, and
the calcium sulfate in an amount of 2 to 100, preferably 5 to 75, more preferably 10 to 50 parts by weight per 100 pbw of aluminate cement, wherein the calcium sulfate is selected from at least one member of the group consisting of calcium sulfate dihydrate, calcium sulfate hemihydrate, and anhydrous calcium sulfate.

Clause 15. The method of clause 13 or 14, wherein the inorganic mineral comprising alkaline earth metal oxide comprises calcium oxide, or magnesium oxide or a combination of calcium oxide and magnesium oxide; wherein the thermally activated aluminosilicate mineral comprises at least 75% Class C fly ash.

Clause 16. The method of clause 13, 14 or 15,

wherein the mixture is mixed at an initial temperature of about 0 to about 122° F. (0 to 50° C.),

wherein the mixture contains at least one member of the group consisting of the air-entraining agent and the surface active organic polymer.

Clause 17. The method of clause 13, 14 or 15, wherein the slurry is aerated by mixing the formed slurry to directly entrain air into the slurry in a high shear mixer at a speed of RPM>100 for 1.5 to 8 minutes.

Clause 18. The method of clause 13, 14 or 15, wherein the slurry is aerated by mixing the formed slurry to directly entrain air into the slurry in a low shear mixer at a speed of RPM<100 for 2 to 12 minutes.

Clause 19. The method of any of clauses 13 to 18, wherein the slurry comprises the rheology modifier, the defoaming agent, the air entraining agent, and the surface active organic polymer, wherein the slurry has an absence of Portland cement.

Clause 20. The method of clause 14 or 15, wherein the slurry comprises:

25 to 40 parts said aluminate cement by weight per 100 pbw of thermally activated aluminosilicate mineral, the aluminate cement comprising the calcium sulfoaluminate cement and the calcium aluminate cement, wherein the amount of the calcium aluminate cement is about 30-45 parts by weight (pbw) per 100 pbw of total calcium sulfoaluminate cement and calcium aluminate cement, wherein the composition has an absence of Portland cement;

the air entraining agent,

the defoamer,

the superplasticizer comprising polycarboxylate polyether;

the surface active polymer comprising redispersible film forming polymer;

greater than 0 to at most 5 parts by weight fine aggregate per 1 part total weight of the cementitious reactive powder;

0 to 5.5 parts by weight coarse aggregate per 1 part total weight of the cementitious reactive powder,

the alkali metal salt chemical activator comprises potassium citrate;

air content of about 4% to 12% by volume,

wherein the thermally activated aluminosilicate mineral comprises at least 75% Class C fly ash.

Clause 21. The method of clause 13, 14 or 15, wherein the slurry comprises:

the alkali metal salt chemical activator comprising potassium citrate;

the air-entraining agent in an amount equal to 0.03-0.1 wt % based upon total weight of the cementitious reactive powder, wherein the air entraining agent comprises one or more of wood resin, vinsol resin, wood rosin, gum rosin, tall oil rosin, or salts thereof;

the defoamer in an amount equal to 0.02-0.1 weight % based upon the total weight of the cementitious reactive powder;

the redispersible film forming polymer in an amount equal to 3-10 wt % based upon the total weight of the cementitious reactive powder, wherein said redispersible film forming polymer comprises at least one member selected from the group consisting of acrylate polymer or acrylate co-polymer, vinyl acetate ethylene copolymer, styrene butadiene rubber, and styrene-acrylic copolymer;

1 to 8 parts by weight total fine and coarse aggregate per 1 part total weight of the cementitious reactive powder wherein there is greater than 0 to at most 3.5 parts by weight fine aggregate per 1 part total weight of the cementitious reactive powder, and 0 to 4.5 parts by weight coarse aggregate per 1 part total weight of the cementitious reactive powder;

wherein the air content is about 4% to 8% by volume;

wherein mixing occurs at a mixing speed of 25 RPM or less for a mixing time of 4 to 8 minutes,

wherein the water/cementitious reactive powder weight ratio is 0.18 to 0.45:1; wherein the composition has a Durability Factor (DF) measured according to ASTM C666/C666M—15 greater than 85% for 300 freeze-thaw cycles.

Clause 22. The method of clause 13, 14 or 15, wherein the set composition has a freeze-thaw durability performance according to ASTM C666/C 666M-15 of a relative dynamic modulus of greater than 80 percent for at least 300 freeze-thaw cycles, preferably at least 600 freeze-thaw cycles, more preferably at least 900 freeze-thaw cycles, most preferably at least 1200 freeze-thaw cycles.

Clause 23. A method for repairing pavement comprising filling a crack of the pavement or pothole of the pavement with an aqueous mass of the composition of clause 1, 2 or 3, the filled mass having a thickness of at least 1 inch, wherein the composition comprises fine aggregate and water, and setting the mass in the crack or pothole to form the set composition.

Clause 24. The composition of any of clauses 1-12 and the method of any of clauses 13-23, wherein the inorganic mineral comprising alkaline earth metal has alkaline earth metal oxide content greater than 50 wt %, preferably greater than 60 wt %, more preferably greater than 70 wt %, and most preferably greater than 80 wt %, for example greater than 90 wt %.

It will be understood by those skilled in the art to which this disclosure is directed that modifications and additions may be made to the invention without departing from its scope.

1. A geopolymer composition comprising a mixture of:
cementitious reactive powder comprising:
thermally activated aluminosilicate mineral in an amount of 100 parts by weight, wherein preferably the thermally activated aluminosilicate mineral comprises at least 75% Class C fly ash, and
inorganic mineral comprising alkaline earth metal oxide, wherein the inorganic mineral comprising alkaline earth metal oxide is in an amount of 0.50 to 40 parts by weight (pbw) per said 100 parts by weight of thermally activated aluminosilicate mineral,
optionally at least one aluminate cement, and
optionally at least one calcium sulfate; and
alkali metal chemical activator in an amount of 1 to 6 weight % based upon the total weight of the cementitious reactive powder, wherein the alkali metal chemical activator is selected from at least one member of the group consisting of an alkali metal salt and an alkali metal base, wherein potassium citrate is the preferred alkali metal salt chemical activator;
freeze-thaw durability component in an amount of 0.05 to 21.5 weight % based upon the total weight of the cementitious reactive powder, the freeze-thaw durability component comprising:
air-entraining agent in an amount of 0 to 1 weight % based upon the total weight of the cementitious reactive powder,
defoaming agent in an amount of 0 to 0.5 weight % based upon the total weight of the cementitious reactive powder, and
surface active organic polymer in an amount of 0 to 20 weight % based upon the total weight of the cementitious reactive powder;
wherein at least one member of the group consisting of the air-entraining agent and the surface active organic polymer is present,
wherein the composition has an air content of about 3% to 20% by volume,
wherein said thermally activated aluminosilicate mineral, said optional aluminate cement, said optional calcium sulfate, and said inorganic mineral comprising alkaline earth metal oxide is at least 70 wt. % of the cementitious reactive powder.

2. The composition of claim 1, wherein the cementitious reactive powder further comprises:
the aluminate cement in an amount of 1 to 100 parts by weight (pbw) per 100 parts by weight of thermally activated aluminosilicate mineral, and
the calcium sulfate in an amount of 2 to 100 parts by weight per 100 parts by weight of aluminate cement, wherein the calcium sulfate is selected from at least one member of the group consisting of calcium sulfate dihydrate, calcium sulfate hemihydrate, and anhydrous calcium sulfate.

3. The composition of claim 1, wherein the inorganic mineral comprising alkaline earth metal oxide comprises calcium oxide, or magnesium oxide or a combination of calcium oxide and magnesium oxide;
wherein the thermally activated aluminosilicate mineral comprises at least 75% Class C fly ash.

4. The composition of claim 1,
wherein the composition is made from setting a slurry comprising water, the cementitious reactive powder, the alkali metal chemical activator, and the freeze-thaw durability component, wherein the water/cementitious reactive powder weight ratio of the slurry is 0.14 to 0.55:1,
wherein the composition contains at least one feature selected from the group consisting of:
air-entraining agent in an amount of 0.01 to 1 weight % based upon the total weight of the cementitious reactive powder, and
surface active organic polymer in an amount of 1 to 20 weight % based upon the total weight of the cementitious reactive powder,
wherein the composition after setting has a relative dynamic modulus greater than 80% for at least 100 freeze-thaw cycles according to ASTM C666/C666M-15, and
wherein the composition after setting has a weight loss less than 1% after 25 freeze-thaw cycles according to this ASTM C672/C672M-12 salt scaling test,
wherein the composition has a Durability Factor (DF) measured according to ASTM C666/C666M—15 greater than 85% for 100 freeze-thaw cycles.

5. The composition of claim 2, wherein the aluminate cement comprises calcium sulfoaluminate cement provided in an absence of calcium aluminate cement and an absence of Portland cement.

6. The composition of claim 2, wherein the aluminate cement comprises calcium aluminate cement provided in an absence of calcium sulfoaluminate cement and an absence of Portland cement.

7. The composition of claim 2, comprising 5 to 60 parts aluminate cement by weight per 100 pbw of thermally activated aluminosilicate mineral, the aluminate cement comprising calcium sulfoaluminate cement and calcium aluminate cement, wherein the amount of calcium aluminate cement is about 5 to about 75 parts by weight (pbw) per 100 pbw of total calcium sulfoaluminate cement and calcium aluminate cement, wherein the composition has an absence of Portland cement.

8. The composition of claim 1, comprising the air entraining agent and the surface active organic polymer,
wherein the surface active organic polymer comprises at least one member of the group consisting of biopolymers, organic rheology control agents, film forming redispersible polymers, and film forming polymer of film forming polymer dispersions,
wherein the biopolymer is selected from at least one member of the group consisting of Succinoglycans, diutan gum, guar gum, wellan gum, xanthan gums galactomannan gums, glucomannan gums, guar gum, locust bean gum, cara gum, hydroxyethyl guar, hydroxypropyl guar, cellulose, hydroxypropyl cellulose, hydroxymethyl cellulose, and hydroxyethyl cellulose,
wherein the at least one organic rheology control agent comprises at least one acrylic-based polymer selected from the group consisting of alkali-swellable (or soluble) emulsions (ASE's), hydrophobically modified alkali-swellable emulsions (HASE's), and hydrophobically modified, ethoxylated urethane resins (HEUR's),
wherein the film forming redispersible polymer is selected from the group consisting of (meth)acrylic polymers, styrene polymers, styrene-butadiene rubber polymers, vinyl polymers, polyesters, polyurethanes, polyamides, chlorinated polyolefins, and mixtures or copolymers thereof, wherein said film forming polymer has a glass transition temperature (Tg) of from −40° to 70° C., and
wherein the film forming polymer of the film forming polymer dispersions is selected from the group consisting of (meth)acrylic polymers, styrene polymers, styrene-butadiene rubber polymers, vinyl polymers, polyesters, polyurethanes, polyamides, chlorinated polyolefins, and mixtures or copolymers thereof, wherein said film forming polymer has a glass transition temperature (Tg) of from −40° to 70° C.

9. The composition of claim 1, wherein the composition has a freeze-thaw durability performance according to ASTM C666/C 666M-15 of a relative dynamic modulus of greater than 80 percent for at least 100 freeze-thaw cycles.

10. The composition of claim 1,
wherein the aluminate cement and calcium sulfate are absent;
wherein the cementitious reactive powder has:
100 pbw thermally activated aluminosilicate mineral and 0.50-40 pbw inorganic mineral comprising alkaline earth metal oxide.

11. The composition of claim 1, comprising, 0 to 5 parts by weight fine aggregate per 1 part total weight of the cementitious reactive powder;
0 to 5.5 parts by weight coarse aggregate per 1 part total weight of the cementitious reactive powder;
25 to 40 parts said aluminate cement by weight per 100 pbw of thermally activated aluminosilicate mineral, the aluminate cement comprising calcium sulfoaluminate cement and calcium aluminate cement, wherein the amount of the calcium aluminate cement is about 30-45 parts by weight (pbw) per 100 pbw of total calcium sulfoaluminate cement and calcium aluminate cement, wherein the composition has an absence of Portland cement;
the air entraining agent,
the defoamer,
the superplasticizer comprising polycarboxylate polyether;
the surface active polymer comprising redispersible film forming polymer;
greater than 0 to at most 5 parts by weight fine aggregate per 1 part total weight of the cementitious reactive powder;
0 to 5.5 parts by weight coarse aggregate per 1 part total weight of the cementitious reactive powder;
the alkali metal salt chemical activator comprises potassium citrate;
air content of about 4% to 12% by volume;
wherein the thermally activated aluminosilicate mineral comprises at least 75% Class C fly ash.

12. The composition of claim 1,
wherein the aluminate cement and calcium sulfate are present; and
wherein the cementitious reactive powder:
has 100 pbw thermally activated aluminosilicate mineral, 1-100 pbw aluminate cement, 2-100 pbw calcium sulfate, and 0.50-40 pbw inorganic mineral comprising alkaline earth metal oxide.

13. A method for making geopolymer compositions of claim 1, comprising the steps of: preparing a slurry by mixing
water;
cementitious reactive powder comprising:
thermally activated aluminosilicate mineral in an amount of 100 parts by weight, and
inorganic mineral comprising alkaline earth metal oxide, wherein the inorganic mineral comprising alkaline earth metal oxide is in an amount of 0.50 to 40 pbw per 100 parts by weight of thermally activated aluminosilicate mineral,
optionally at least one aluminate cement,
optionally at least one calcium sulfate; and
alkali metal chemical activator in an amount of 1 to 6 weight % based upon the total weight of the cementitious reactive powder, wherein the alkali metal chemical activator is selected from at least one member of the group consisting of an alkali metal salt and an alkali metal base;
freeze-thaw durability component in an amount of 0.05 to 21.5 weight % based upon the total weight of the cementitious reactive powder, the freeze-thaw durability component comprising:
air-entraining agent in an amount of 0 to 1 weight % based upon the total weight of the cementitious reactive powder,
defoaming agent in an amount of 0 to 0.5 weight % based upon the total weight of the cementitious reactive powder, and
surface active organic polymer in an amount of 0 to 20 weight % based upon the total weight of the cementitious reactive powder;
wherein at least one member of the group consisting of the air-entraining agent and the surface active organic polymer is present,
wherein the slurry has an air content of about 3% to 20% by volume,
wherein said thermally activated aluminosilicate mineral, said optional aluminate cement, said optional calcium sulfate, and said inorganic mineral comprising alkaline earth metal oxide is at least 70 wt. % of the cementitious reactive powder;
wherein the water/cementitious reactive powder weight ratio of the slurry is 0.14 to 0.55:1,
setting the slurry to form a set composition.

14. The method of claim 13, wherein the cementitious reactive powder further comprises:
the aluminate cement in an amount of 1 to 100 parts by weight (pbw) per 100 pbw of thermally activated aluminosilicate mineral, and
the calcium sulfate in an amount of 2 to 100 parts by weight per 100 pbw of aluminate cement, wherein the calcium sulfate is selected from at least one member of the group consisting of calcium sulfate dihydrate, calcium sulfate hemihydrate, and anhydrous calcium sulfate.

15. The method of claim 13, wherein the inorganic mineral comprising alkaline earth metal oxide comprises calcium oxide, or magnesium oxide or a combination of calcium oxide and magnesium oxide; wherein the thermally activated aluminosilicate mineral comprises at least 75% Class C fly ash.

16. The method of claim 13, wherein the mixture is mixed at an initial temperature of about 0 to about 122° F. (0 to 50° C.), wherein the mixture contains at least one member of the group consisting of the air-entraining agent and the surface active organic polymer.

17. The method of claim 13, wherein the slurry is aerated by mixing the formed slurry to directly entrain air into the slurry in a high shear mixer at a speed of RPM>100 for 1.5 to 8 minutes.

18. The method of claim 13, wherein the slurry is aerated by mixing the formed slurry to directly entrain air into the slurry in a low shear mixer at a speed of RPM<100 for 2 to 12 minutes.

19. The method of claim 13, wherein the slurry comprises the rheology modifier, the defoaming agent, the air entraining agent, and the surface active organic polymer, wherein the slurry has an absence of Portland cement.

20. A method for repairing pavement comprising filling a crack of the pavement or pothole of the pavement with an aqueous mass of the composition of claim 1, the filled mass having a thickness of at least 1 inch, wherein the composition comprises fine aggregate and water, and setting the mass in the crack or pothole to form the set composition.
